(19) United States
(12) Patent Application Publication
(10) Pub. No.: US 2014/0188763 A1
(43) Pub. Date: Jul. 3, 2014

(54) SYSTEMS AND METHODS FOR ADJUSTING COST BASIS AND CALCULATING MARKET VALUES AND INVESTMENT PERFOMANCE IN AN INVESTMENT PORTFOLIO

(71) Applicant: NetWorth Services, Inc., Phoenix, AZ (US)

(72) Inventor: Nico Willis, Phoenix, AZ (US)

(21) Appl. No.: 14/160,298

(22) Filed: Jan. 21, 2014

Related U.S. Application Data
(63) Continuation-in-part of application No. 13/550,458, filed on Jul. 16, 2012.
(60) Provisional application No. 61/754,610, filed on Jan. 20, 2013.
(60) Provisional application No. 61/508,009, filed on Jul. 14, 2011.

(51) Int. Cl. G06Q 40/06

(52) U.S. Cl. CPC G06Q 40/06
USPC 705/36 R

(57) ABSTRACT

A financial advisory system for evaluating a plurality assets for an asset owner, comprising a user interface, a database, a performance engine, and a display. The user interface is configured to receive identifying information about the plurality of assets via an application program interface. The database is communicatively linked to the application program interface and configured to store the identifying information, retrieve asset data from a repository database, the asset data comprising historical information about the plurality of assets; and retrieve information about market trends from an authoritative source. The performance engine is communicatively linked to the database and configured to calculate an investment performance of the plurality of assets and generate an alert in response to a sale of at least one of the plurality of assets. The display is configured to present a report of the activity of the plurality of assets.

### CROSS-REFERENCE TO RELATED APPLICATIONS

The present application claims the benefit of and priority to Provisional Patent Application Ser. No. 61/754,610, entitled SYSTEMS AND METHODS FOR ADJUSTING COST BASIS AND CALCULATING MARKET VALUES AND INVESTMENT PERFORMANCE IN AN INVESTMENT PORTFOLIO, filed on Jan. 20, 2013 and is a continuation in part of U.S. patent application Ser. No. 13/550,458, filed on Jul. 16, 2012, which claims the benefit of and priority to Provisional Patent Application Ser. No. 61/508,009, entitled SYSTEMS AND METHODS FOR OPTIMIZING AN INVESTMENT PORTFOLIO, filed on Jul. 14, 2011 and incorporates the disclosure of each application by reference.

### BACKGROUND OF THE INVENTION

An investment portfolio has many types assets such as equities, cash, cash equivalents, options, real estate and fixed-income assets. Diversifying assets among a broad range of asset classes is generally considered to be an important part of constructing a balanced investment portfolio to achieve the financial goals of the investor, manage changes in economic trends, and comport with the investor's tolerance for risk.

The assets in each asset class in an investment portfolio may belong to a wide variety of industry segments with each segment comprising companies with similar business activities, such as energy, electronics, and/or retail. The assets in each asset class may also belong to a sector comprising of general segments of an economy, such as basic materials, financial services, and/or technology. These sectors can be further divided into the industry segments.

### SUMMARY OF INVENTION

Systems and methods for determining adjusting cost basis of assets in an investment portfolio according to various aspects of the present invention may comprise a graphical user interface, database, a cost basis engine, an asset allocation engine, a performance engine, and a graphical display. The graphical user interface may be configured to receive identifying information about the assets and a financial risk tolerance profile of the asset owner. The database may be configured to store and/or retrieve information associated with the assets. The performance engine may be configured to calculate market valuations, assess investment performance of a plurality of assets within an asset owner's investment portfolio, and generate a report of various asset activity.

### BRIEF DESCRIPTION OF THE FIGURES

A more complete understanding of the present invention may be derived by referring to the detailed description when considered in connection with the following illustrative figures. In the following figures, like reference numbers refer to similar elements and steps throughout the figures.

FIG. 1A block diagrams representatively illustrating a financial advisory system in accordance with an exemplary embodiment of the present invention;

FIGS. 2A and 2B depict a screen shot of a graphical user interface that may be accessed by a user to identify the user and for the user to enter a listing of financial accounts in accordance with an embodiment of the present invention;

FIG. 2C depicts a screen shot of a graphical user interface that may be accessed by a user to utilize a tools module;

FIG. 2D depicts a screen shot of a graphical user interface that may be accessed by a user to within the dashboard to verify transfers of assets and/or securities;

FIGS. 3A and 3B depict screen shots of a graphical user interface that may be accessed by a user to enter information relating to the risk tolerance of the asset owner in accordance with an embodiment of the present invention;

FIG. 4A-4F depict screen shots of a graphical user interface that may be accessed by a user to edit asset data in accordance with an embodiment of the present invention;

FIGS. 5A-5F depict screen shots of a graphical user interface that may be accessed by a user to view uploaded asset data in accordance with an embodiment of the present invention;

FIG. 6 depicts a screen shot of a graphical user interface that may be accessed by a user to view alerts relating to the assets in accordance with an embodiment of the present invention;

FIGS. 7A and 7B depict screen shots illustrating a sale planning module in accordance with an embodiment of the present invention;

FIGS. 8-8L depict screen shots illustrating reports that may be generated by the financial advisory system in accordance with an embodiment of the present invention;

FIG. 9 depicts a screen shot illustrating an edit target allocation model in accordance with an embodiment of the present invention; and

FIGS. 10A and 10B depict a screen shot of a graphical user interface that may be accessed by a user to utilize a dashboard illustrating an existing asset allocation scheme and a target asset allocation model, a wash sale alert, and account performance in accordance with an embodiment of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various process steps, apparatus, systems, methods, etc. In addition, the present invention may be practiced in conjunction with any number of systems and methods for providing a computer-implemented system or method for the adjusting the cost basis, calculating market valuations and assessing and/or evaluating investment performance of a plurality of assets within an asset owner's investment portfolio. Further, the present invention may employ any number of conventional techniques for acquiring identifying information for an asset, identifying tax lots, determining the dates of purchase of an asset, evaluating the financial goals and/or risk tolerance of an asset owner, calculating the allocation of assets into asset classes, industry segments, and/or sectors, determining a target allocation of assets for the asset owner, analyzing market trends, evaluating the quality of an asset, determining the compound annual growth rate of an asset, determining the price and/or fair market value of the security, commodity, and/or property at any given time, populating tax reports, and determining gains and/or losses in value of asset, and the like.

The particular implementations shown and described are illustrative of the invention and its best mode and are not intended to limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Various representative implementations of the present invention may be applied to any system or method for adjusting the cost basis, calculating market valuations and evaluating investment performance of a plurality of securities or assets within an asset owner's investment portfolio. The performance engine, as will be discussed below, calculates market values by retrieving prices from the data providers and multiplying the number of shares. The performance engine calculates the investment performance by assessing the portfolio return over daily, monthly, quarterly, and annual periods of time in percentage and absolute terms. The performance algorithms calculate investment performance for the plurality of portfolios on a daily, monthly and quarterly basis. Certain representative implementations may comprise a user interface, such as a website interface or graphical user interface, and/or a database for storing, updating, exchanging, analyzing, processing, communicating, and/or displaying the acquired information relating to calculating market values, investment performance, and the reallocation of assets.

Software and/or software elements according to various aspects of the present invention may be implemented with any appropriate programming or scripting language, such as, C, C++, Java, COBOL, assembler, PERL, eXtensible Markup Language (XML), HTML, PHP, etc., or any other suitable programming and/or scripting language.

Various representative algorithms may be implemented with any suitable combination of data structures, objects, processes, routines and/or other programming elements. Further, the present invention may employ any number of conventional techniques for data transmission, signaling, data processing, network control, and/or the like. Applications according to various aspects of the present invention may be formulated and a network may be provided that may include any system for exchanging data, such as the Internet, an intranet, an extranet, WAN, LAN, satellite communications, any suitable wireless Internet connection, and/or the like. The network may be implemented as other types of networks, such as an interactive television (ITV) network. The users may interact with the system by any input device such as a keyboard, mouse, kiosk, personal digital assistant, handheld computer, cellular phone such as a Smartphone that may have access to the Internet, text messaging by cellular phone, and/or the like. Similarly, the invention may be used in conjunction with any type of personal computer, network computer, workstation, minicomputer, mainframe, or the like running any operating system such as any version of Windows, Windows XP, Windows Longhorn, Windows Whistler, Windows ME, Windows Mobile, Windows NT, Windows 2000, Windows Server, Windows 98, Windows 95, Windows Vista, Windows 7, MacOS, OS/2, BeOS, Linux, UNIX, or any other operating system, whether now known or known hereafter in the art. Moreover, the invention may be implemented with TCP/IP communications, IPX, AppleTalk, IP-6, NetBIOS, OSI or any number of existing or future protocols. Moreover, the system may comprise the use, sale and/or distribution of all goods, services, and/or information having similar functionality described herein.

The system may be connected by a data communication network. The data communication network may be a public network, and may be secure or unsecure and open to eavesdroppers. In one exemplary implementation, the data communication network may be embodied as the Internet. In this context, computers may or may not be connected to the Internet at all times.

A variety of conventional communications media and protocols may be used for data links, such as a connection to an Internet Service Provider (ISP) over a local loop as is typically used in connection with standard modem communication, wireless cellular communication, cable modem, satellite television providers, Integrated Service Digital Network (ISDN), Digital Subscriber Line (DSL), and/or various wireless communication methods. Polymorph code systems might also reside within a local area network (LAN) which interfaces to a network through a leased line (T1, T3, etc.).

The present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in the storage medium. Any suitable non-transitory computer-readable storage medium may be utilized, including hard disks, CD-ROM, optical storage devices, magnetic storage devices, and/or USB memory keys and the like.

Data communication may be accomplished through any suitable communication system, such as, a telephone network, intranet, Internet, point of interaction device (point of sale device, personal digital assistant, cellular phone, kiosk, etc.), online communications, off-line communications, wireless communications, a radio dispatch network, and/or the like. Further, for security reasons, any databases, systems, and/or components of the present invention may comprise any combination of databases or components at a single location or at multiple locations, wherein each database or system includes any of various suitable security features, such as firewalls, access codes, encryption, de-encryption, compression, decompression, and/or the like.

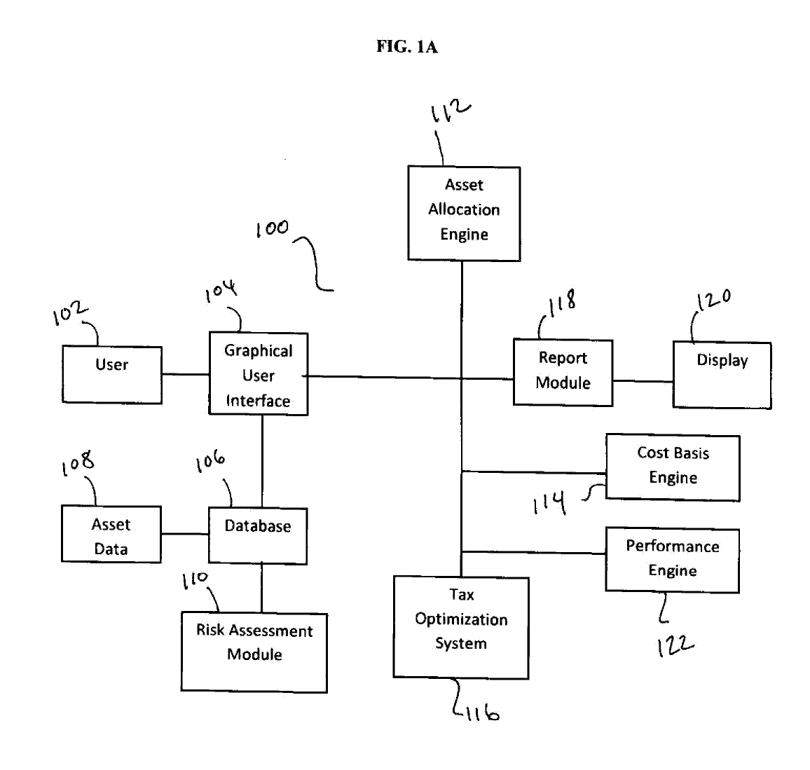

Referring now to FIG. 1, systems and methods for adjusting the cost basis, calculating market valuations and assessing and/or evaluating investment performance of a plurality of securities and assets within an asset owner's investment portfolio according to various aspects of the present invention may be representatively illustrated by a financial advisory system 100 for access by a user 102. The financial advisory system 100 may comprise a graphical user interface 104, such as a website interface, for access by the user 102.

The user 102 may comprise an individual, such as the owner of the plurality of assets (hereinafter the asset owner) that may be subject to evaluation for optimal allocation into at least one of an asset class, an industry segment, and/or a sector. The user 102 may also comprise any suitable person, company, institution and the like that may buy, sell, trade, value, and/or provide financial advice regarding the plurality of assets associated with the asset owner's investment portfolio. For example, the user 102 may comprise an investment broker and/or dealer, a mutual fund company, a tax professional, a government department such as the IRS, and/or a non-profit institution such as a university or charity and the like.

In one embodiment, according to various aspects of the present invention, the user 102 may own, transact business, evaluate and/or otherwise interact with the assets such as securities, commodities, property such as jewelry, art, and/or real estate, intellectual property, goodwill, and equity ownership interests. The user 102 may access the graphical user interface 104, such as through a personal computer or an online website, to determine the optimal allocation for the plurality of assets in the asset owner's investment portfolio.

The graphical user interface 104 may comprise any suitable system for communicating, accessing, updating, exchanging information, organizing information, and/or managing information such as by data collection, encryption, acquisition, storage, dissemination, and the like. In one embodiment, the graphical user interface 104 may comprise a website interface, such as an interface for a web server. For example, the web server may comprise a Microsoft® Windows® Internet Information Services (IIS) Web Server.

In one embodiment, the financial advisory system 100 may comprise a database 106 that may store information entered by the user 102, such as to save the information for the user 102 to access at a later date. The database 106 may also comprise other stored information, such as information further discussed below. The database 106 is updated daily such that the information contained therein is current.

In one embodiment, according to various aspects of the present invention, the database 106 may be accessible by the user 102 via the graphical user interface 104 and may store asset data 108 entered by the user 102. The asset data 108 may comprise any information associated with the plurality of assets in the asset owner's investment portfolio. For example, the asset data 108 may comprise information identifying the asset, such as a security, which may be a bond, stock, mutual fund, option, and/or commodity. The asset data 108 may also comprise real estate, cash and cash equivalents, such as treasury bills, certificates of deposit (CD), and/or money market funds.

The information may comprise a company name, company symbol, and/or a CUSIP number identifying the asset, and may be entered into the graphical user interface 104 by the user 102. In one embodiment, the database 106 may store a directory of company names, symbols, and/or CUSIP numbers for the user 102 to select.

In an exemplary embodiment of the present invention, the database 106 may be accessible to the user 102 via the graphical user interface 104 and may store tax laws and/or regulations, such as the rate of taxation of the asset for use by a tax optimization system 116. The tax optimization system 116 may optimize the selection of tax lots of the plurality of assets entered into the database 106 by the user 102 or otherwise imported into the database 106 to achieve a desired goal by the asset owner and/or the user 102, such as to minimize the tax resulting from the sale of one or more of the plurality of assets. An exemplary tax optimization system 116 is disclosed in U.S. Patent Publication Number 2011/0161247, published Jun. 30, 2011, the contents of which are herein incorporated by reference.

In one embodiment, the financial advisory system 100 may comprise a cost basis engine 114. The cost basis engine 114 may utilize the asset data 108 to create tax lots that may be displayed to the user 102. The cost basis engine 114 may further adjust the cost basis on the assets and or securities, including but not limited to stocks, options, mutual funds, fixed income securities and/or annuities. An exemplary cost basis engine 114 is disclosed in U.S. Pat. No. 7,606,753, U.S. Patent Publication Number 2010/0017343, U.S. patent application Ser. No. 13/972,091, and U.S. patent application Ser. No. 13/972,138 the contents of which are herein incorporated by reference.

In one embodiment, the financial advisory system 100 may comprise a performance engine 122. The performance engine 122 may utilize the asset data 108 to calculate market valuations and assess and/or evaluate investment performance of the assets and securities in the user's portfolio. The market valuations may be calculated by retrieving prices from data providers, such as a repository database (discussed below), and multiplying the number of shares in the portfolio(s). For example, performance engine 122 measures the portfolio's investment performance divided by asset category (i.e. stocks or fixed income) using a rate of return to calculate that asset category performance. The investment performance may be benchmarked against relevant market indices for comparison, such as S&P 500, and MSCI EAFE, which are stored in the database 106. The investment performance may be calculated in Month, Last Quarter, Year-to-Date and/or Last 12 Months intervals. Asset categories may be divided into various types of categories such as, for example, Large Cap, Small Cap, International Stock, Fixed Income, Real Estate, Commodities, Cash, and the like. Each asset category may be benchmarked against its most closely related index (i.e. S&P500, Russell 2000, MSCI EAFE, Barclay Cap Fixed Income, HGX, Dow Jones USM and T-Bill. The asset allocation weight (i.e. Stocks 20%) is applied to each asset category to provide a blended, rate or mixed index for the total portfolio's investment performance.

In one embodiment, according to various aspects of the present invention, the database 106 may access any suitable repository database containing information about the asset. The repository database may be any electronic repository that may be accessible, such as through the Internet. For example, the graphical user interface 104 may access a security database table (not shown) that may store historical price information for the security, such as a stock, bond, mutual fund and/or the like. In one embodiment, the security database table may store a high price, low price, and/or an open price for the security on any day. The security database table may also comprise data for securities having a single price per day, such as mutual funds having a Net Asset Value at close of trading.

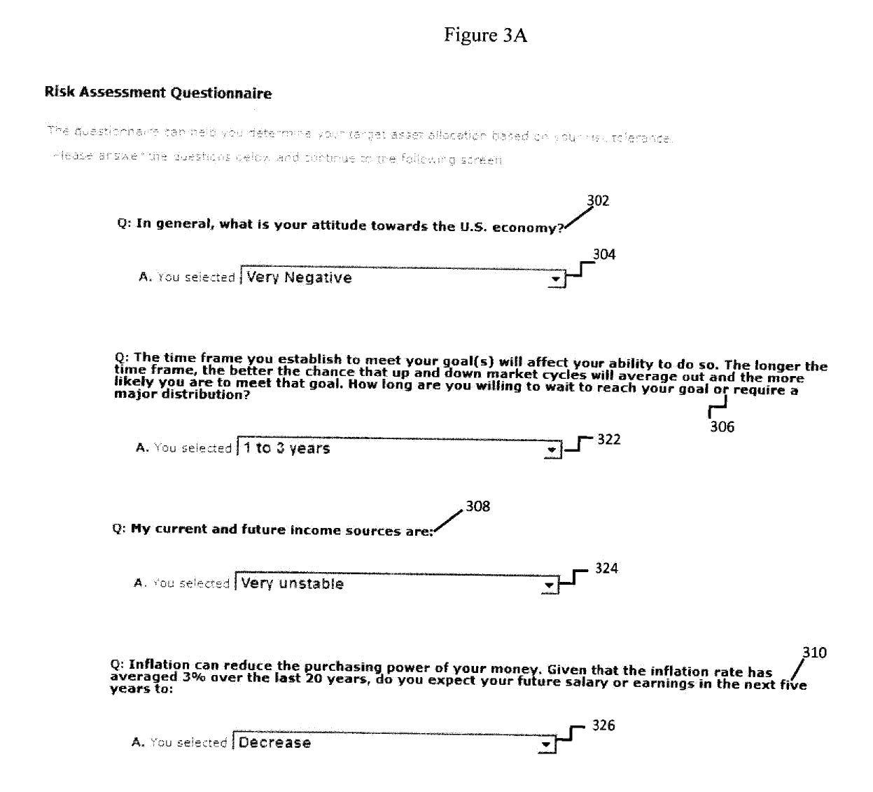

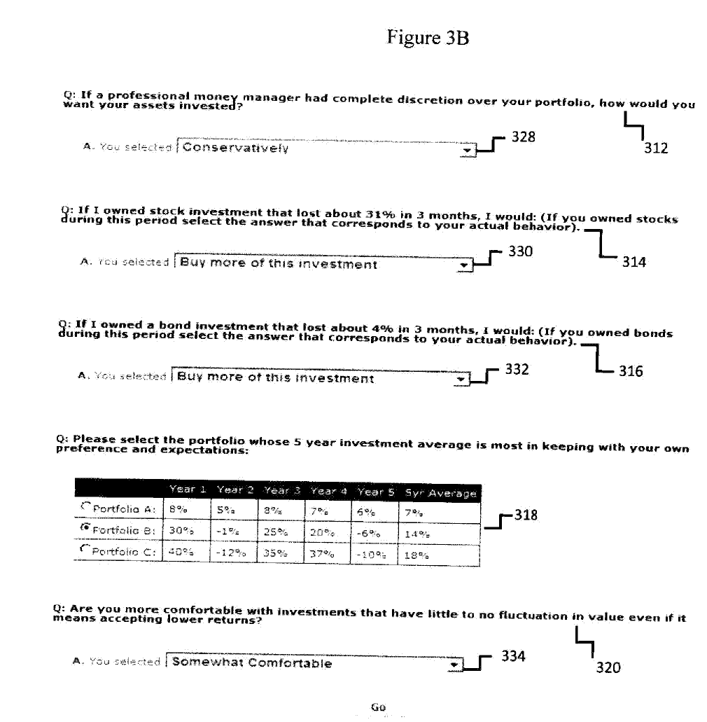

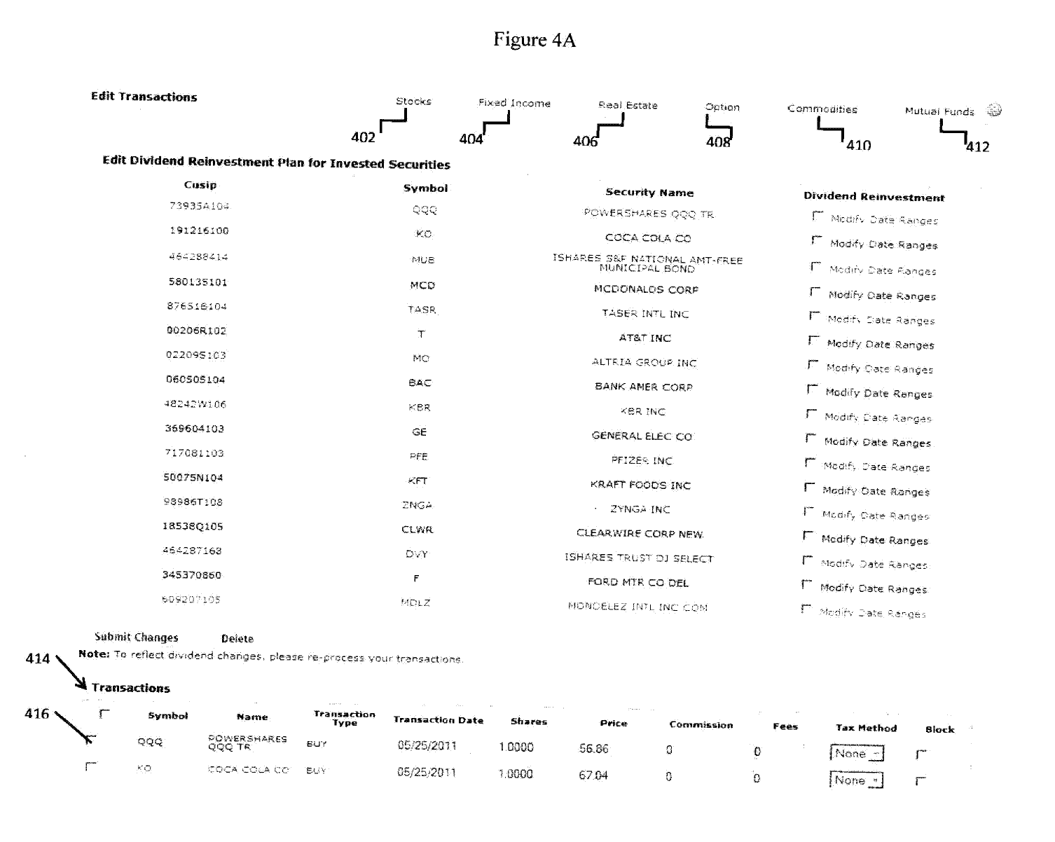

A risk assessment module 110/300 may be communicatively linked to the database 106 and may store asset owner preferences. The asset owner preferences may comprise any preferences of the asset owner related to risk tolerance and/or financial goals. For example, the asset owner preferences may comprise information related to the assets owner's attitude toward economic trends, tolerance for gain and/or loss in asset value, and/or financial strategy in terms of time to retirement, age, income sources and the like, as further discussed below with respect to FIG. 3.

In one embodiment, according to various aspects of the present invention, the financial advisory system 100 may comprise an asset allocation engine 112. The asset allocation engine 112 may perform any suitable processing of the asset data 108 to produce an existing asset allocation scheme. The existing asset allocation scheme may comprise a breakdown of asset classes, industry segments, and/or sectors applicable to the asset data 108. For example, the existing asset allocation scheme may illustrate the percentage of assets in asset data 108 that belong to different asset classes such as stocks, bonds, and cash equivalents. In one embodiment, the existing asset allocation scheme may provide information about the percentage of assets in asset data 108 that belong to particular industry segments and sectors.

In an exemplary embodiment, asset allocation engine 112 may generate a target asset allocation model comprising the optimal allocation of assets to comport with the risk tolerance and financial goals provided in the asset owner preferences in the risk assessment module 110/300, market trends, and information related to the quality of the investments in the asset data 108. In one embodiment, the asset allocation engine 112 may analyze data stored and/or retrieved by the database 106 relating to market trends. For example, market trends may correspond to data from one or more authoritative sources, such as governmental regulatory bodies and/or professional organizations. In one embodiment, an authoritative source may comprise the Jobless Claims Report released weekly by the U.S. Department of Labor, the money supply released by the Federal Reserve as an indicator of inflation, the New Residential Housing Construction Report (also referred to as housing starts) released by the Census Bureau and the Department of Housing and Urban Development (HUD), and/or the Consumer Confidence Index (CCI) released by the Conference Board and the like.

In another embodiment, the asset allocation engine 112 may analyze data retrieved by the database 106 relating to the quality of the assets in the asset data 108. The quality of the assets may refer any indicator of the performance of an asset, such as a company's stock earning a high rate of return or the creditworthiness of the company. For example, the asset allocation engine 112 may review ratings of the asset, such as the Schwab Equity Rating provided by Charles Schwab & Co, Inc., and/or Standard & Poor's credit rating of equities. In one embodiment, the asset allocation engine 112 may recommend that the user 102 dispose of low quality assets and replace them with higher quality assets. Exchanging assets may not change the percentage of the allocation of assets in different asset classes, industry segments, and/or sectors, but may increase the quality of the assets in the investment portfolio.

In some embodiments, the asset allocation engine 112 may use variables assigned to the risk assessment module 110/300 to determine an appropriate allocation model (for the user), as will be discussed in detail below. Based on the results from the risk assessment module 300, the target asset allocation may be calculated. The target allocation may also be manually inputted by the user, if the risk assessment module 300 does not generate a target consistent with the user's intent.

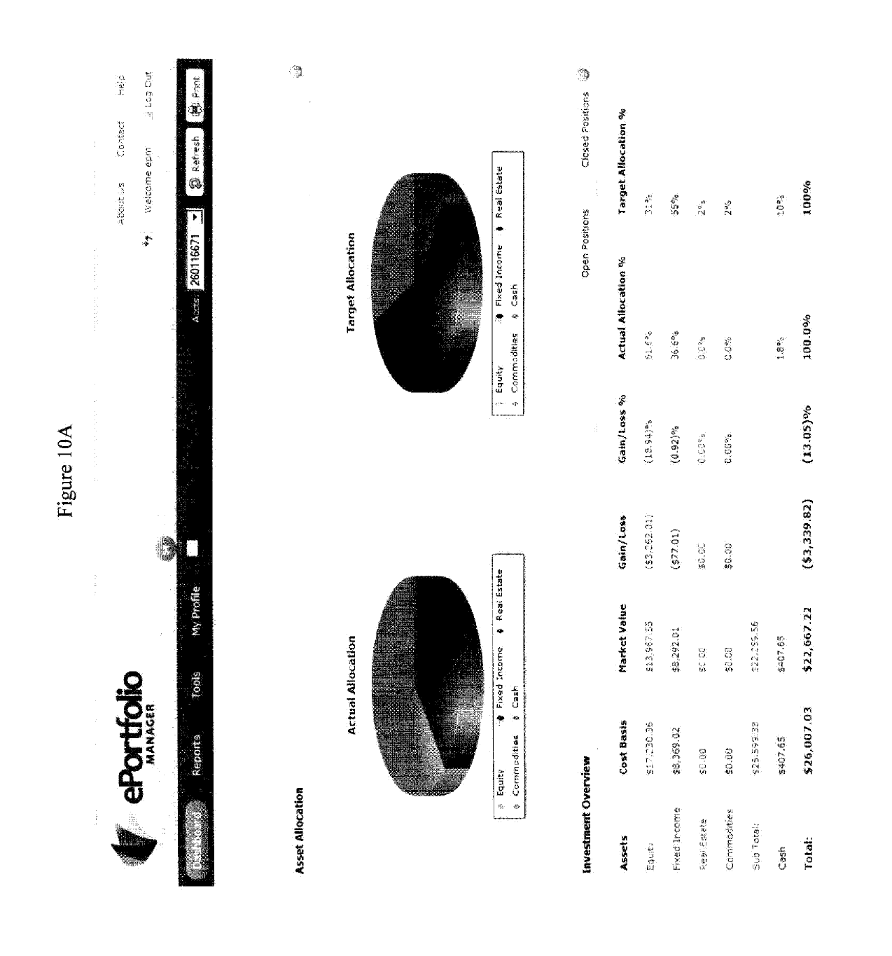

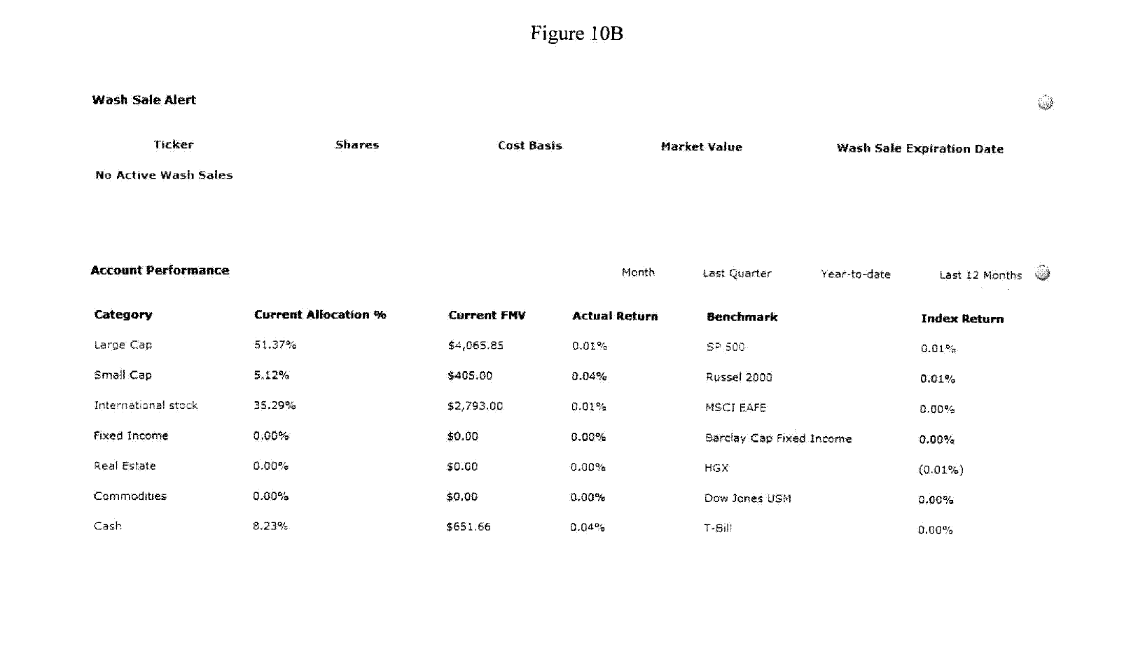

The asset allocation engine 112 may compare the existing asset allocation scheme to the target asset allocation model to identify deficiencies. In one embodiment, a deficiency may comprise an asset to be acquired or disposed of to modify the existing asset allocation scheme to achieve the target asset allocation model. For example, in one embodiment, a user 102 may be over allocated in stocks and under allocated in fixed income. But after the target allocation model compared to existing asset allocation, the allocation engine 112 will show a deficiency and suggest a reduction of stocks and an increase in fixed income, as will be further discussed below with respect to FIGS. 10A and 10B.

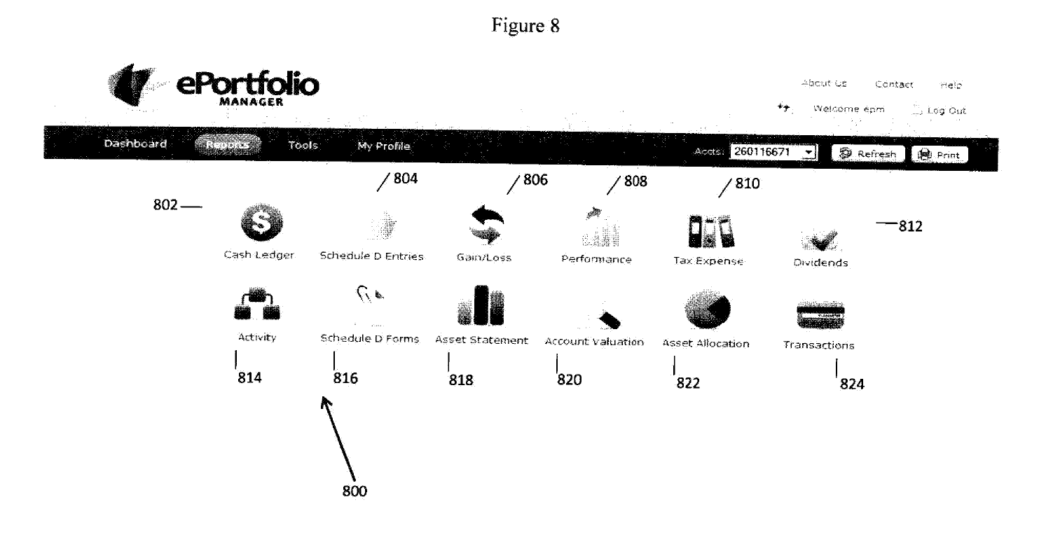

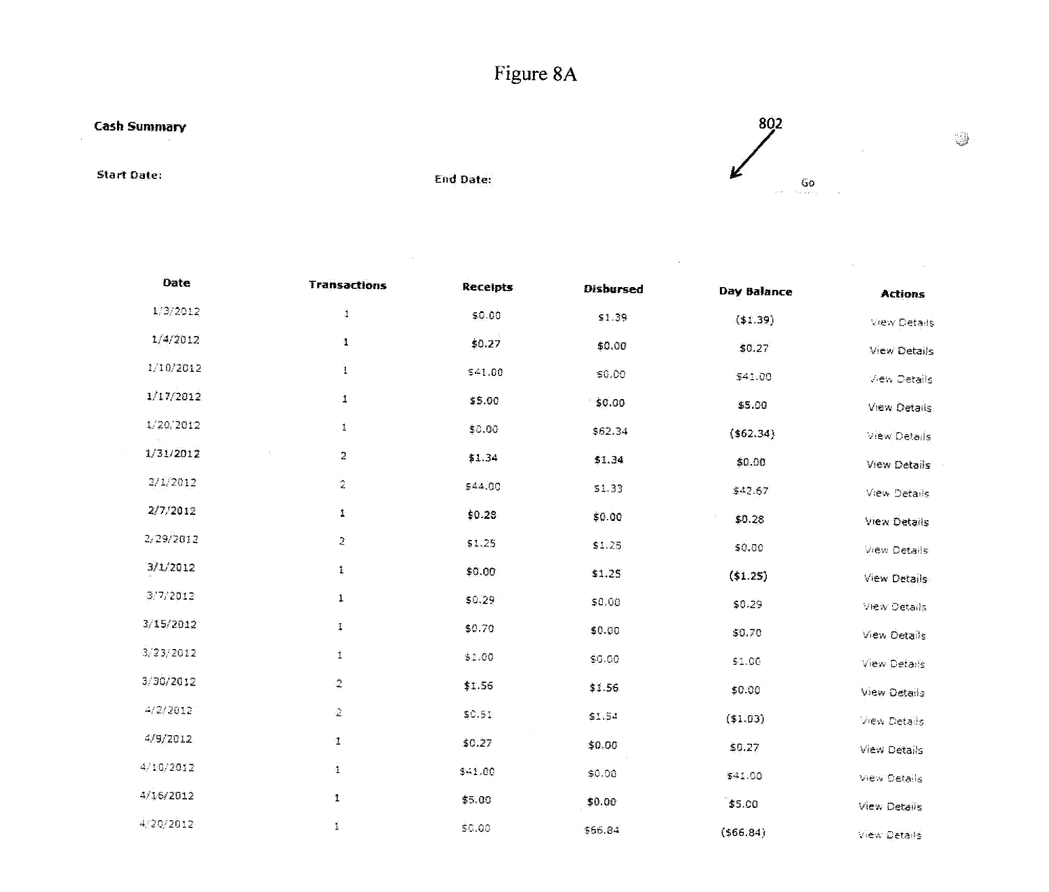

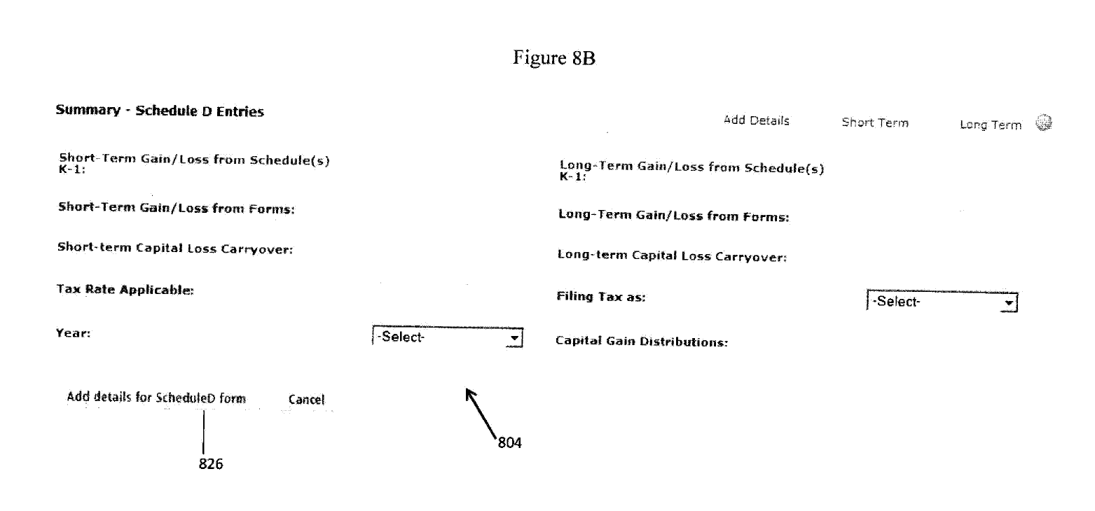

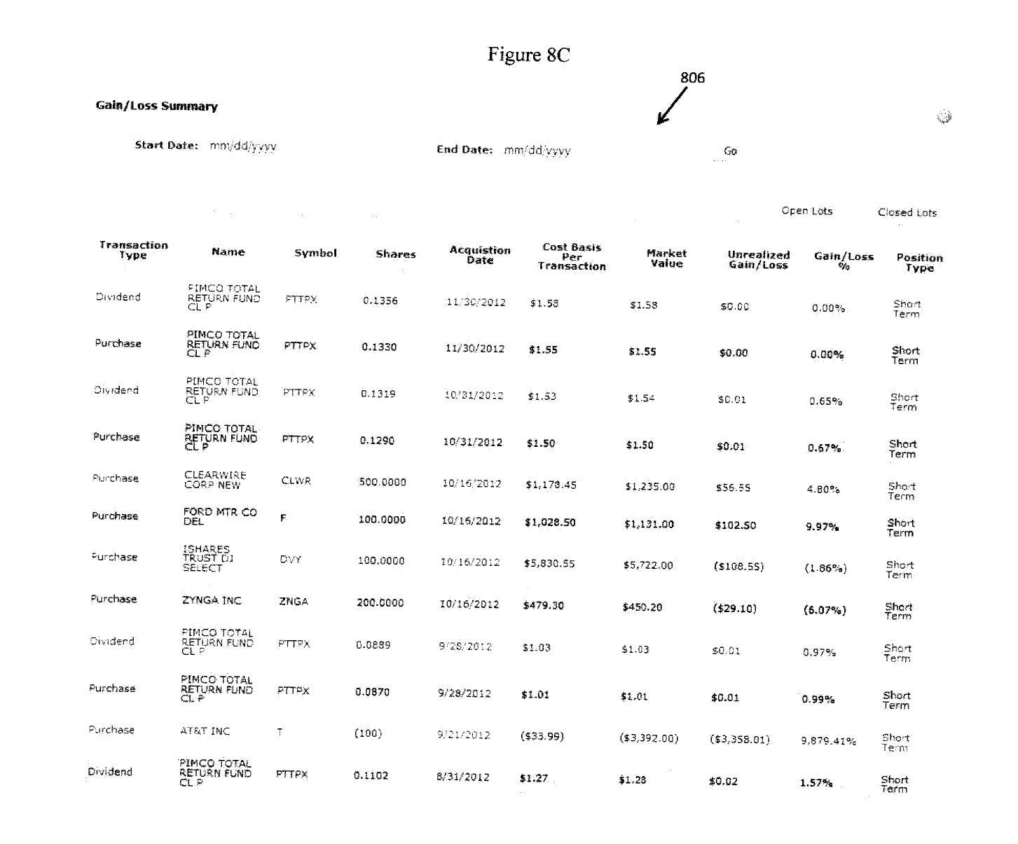

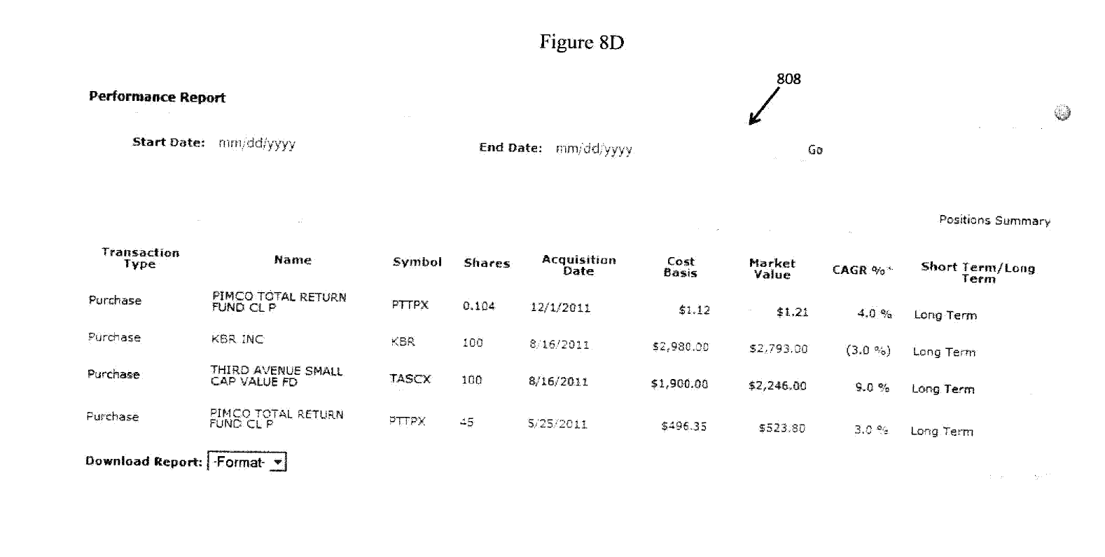

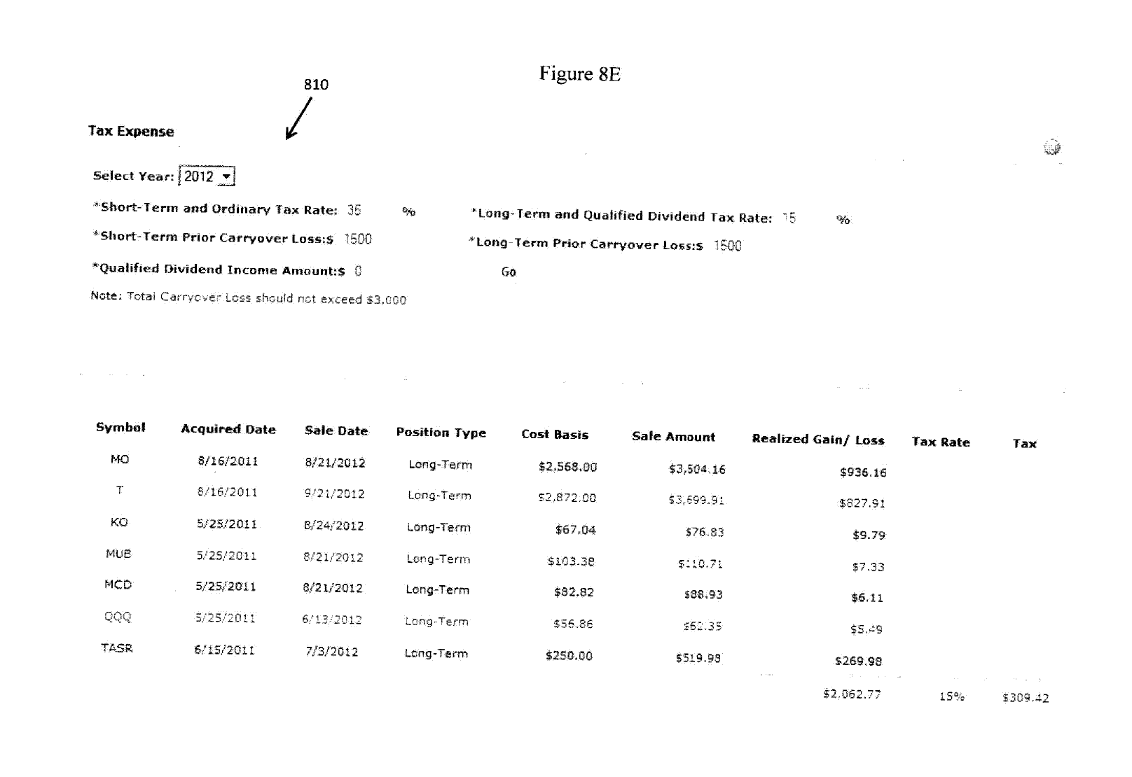

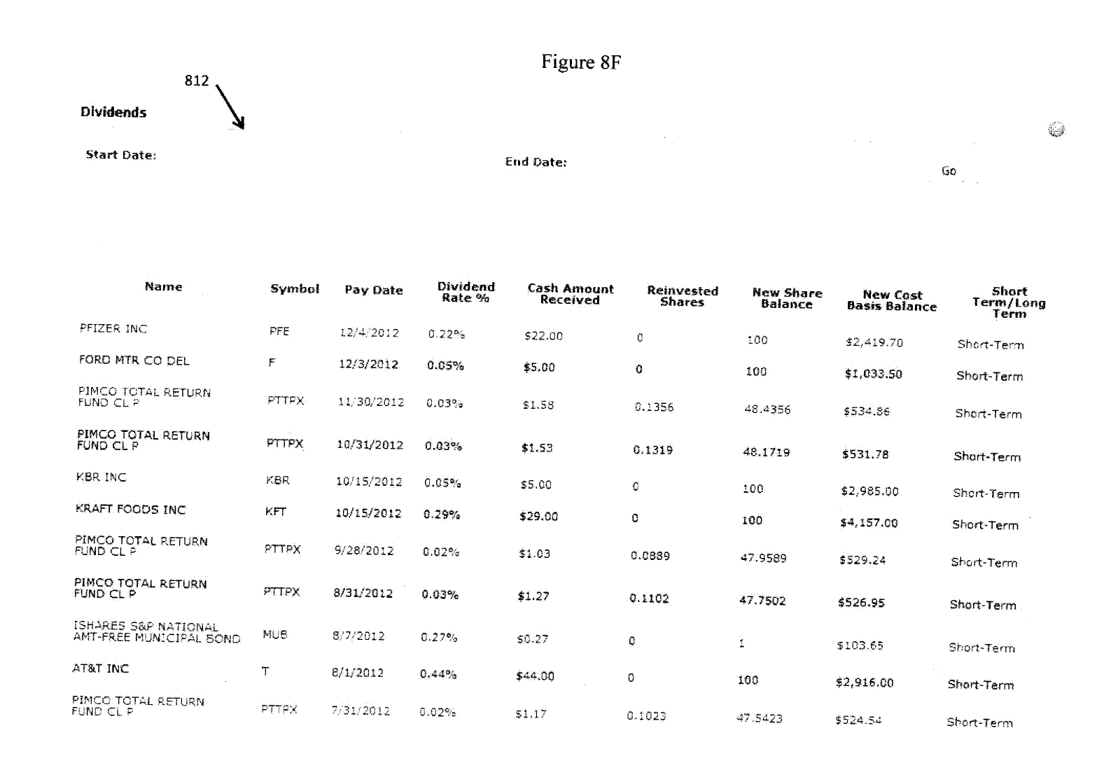

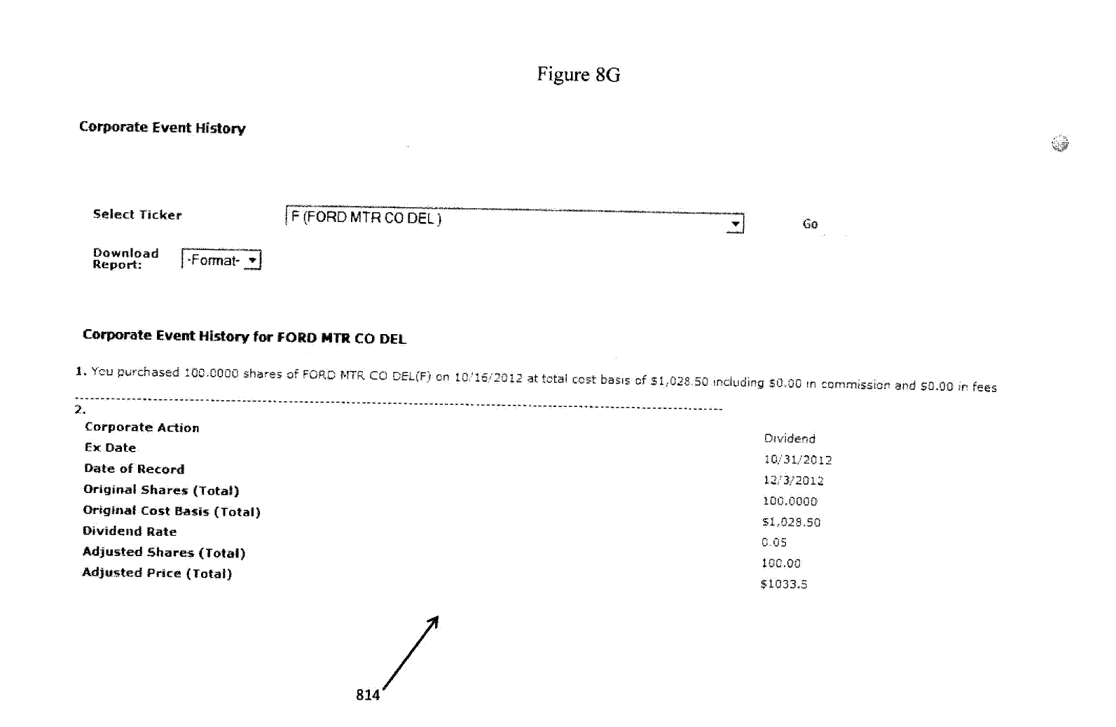

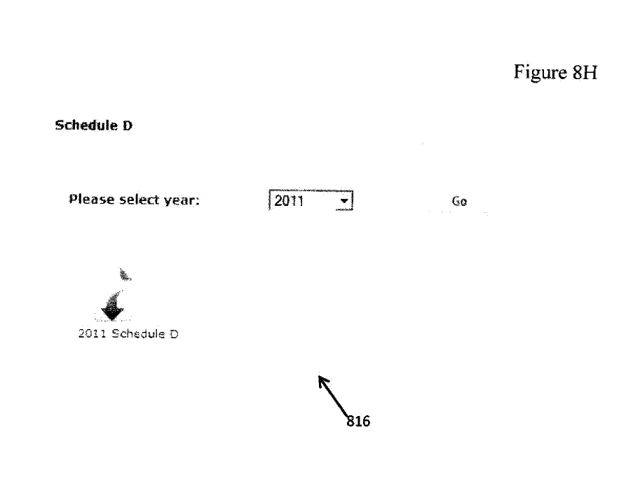

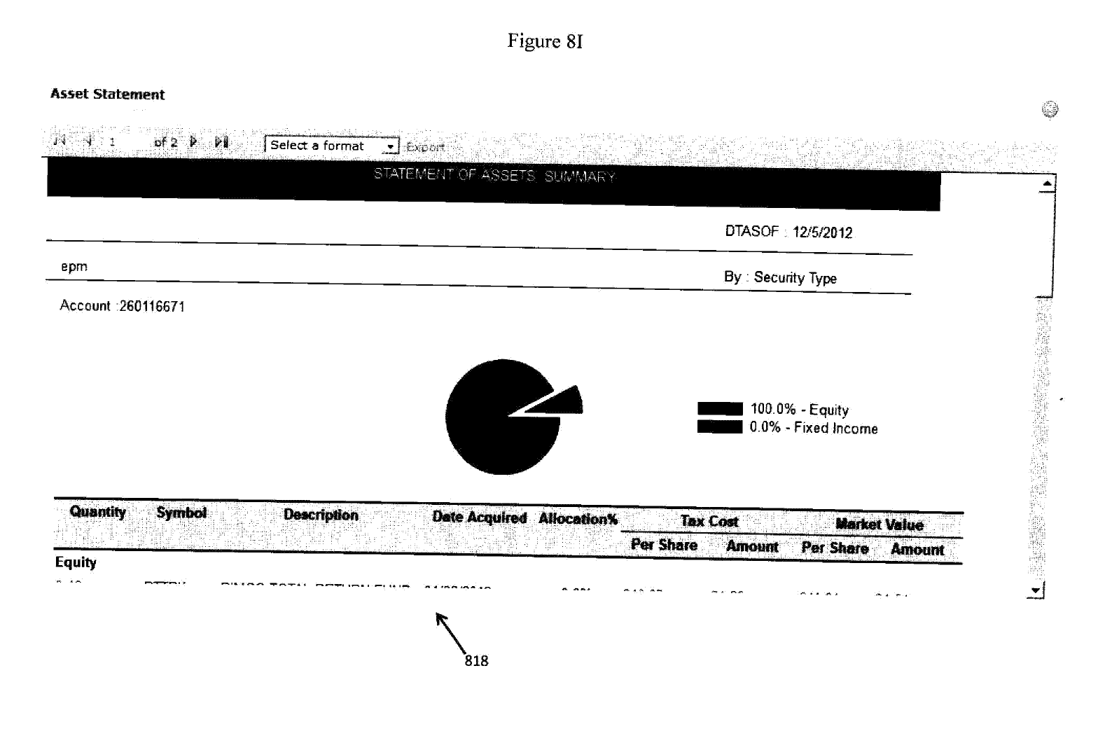

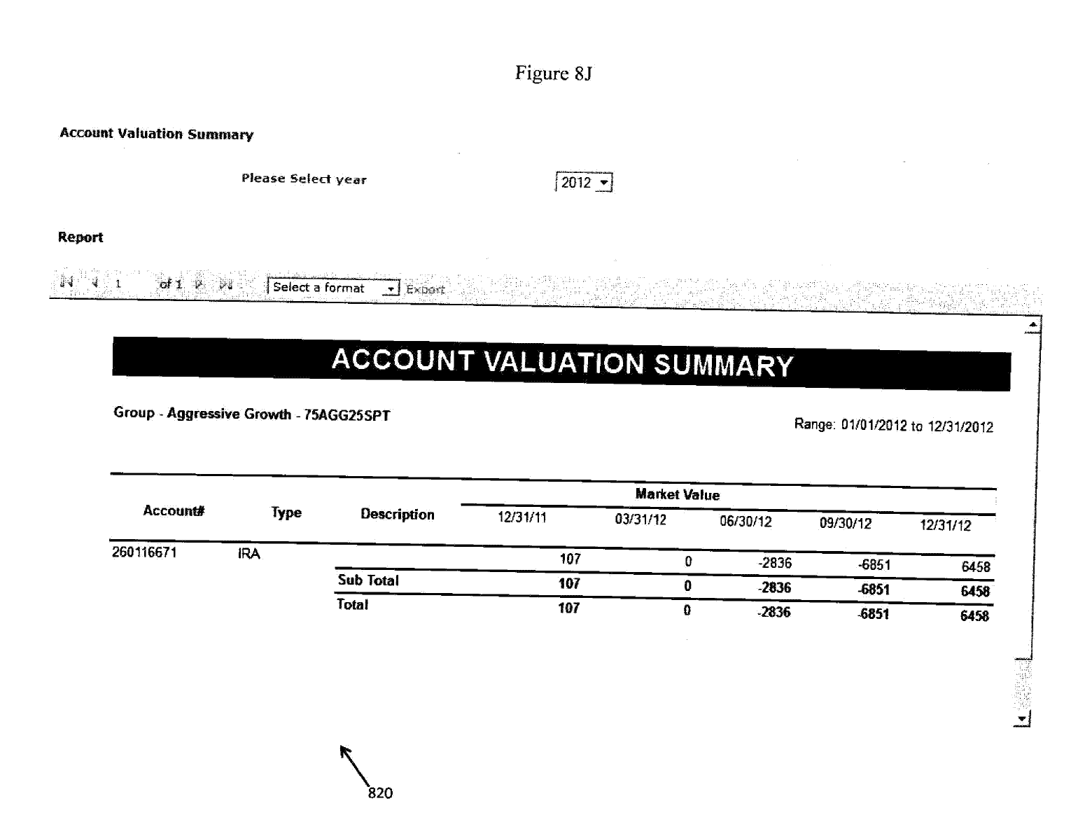

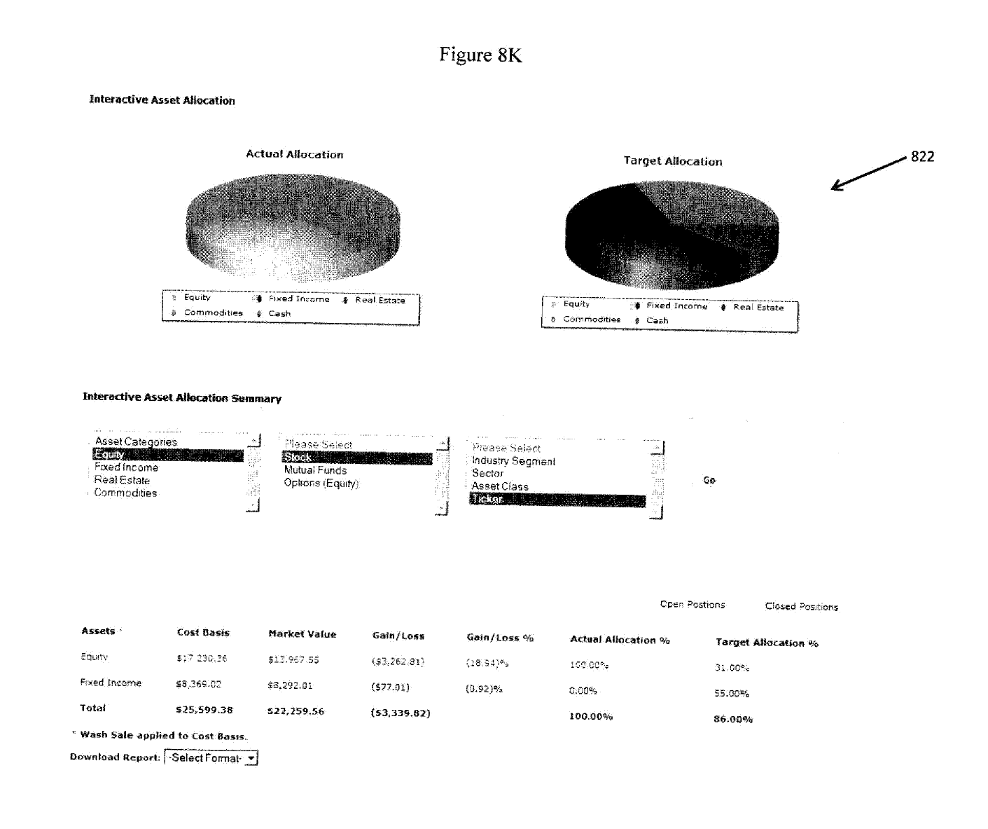

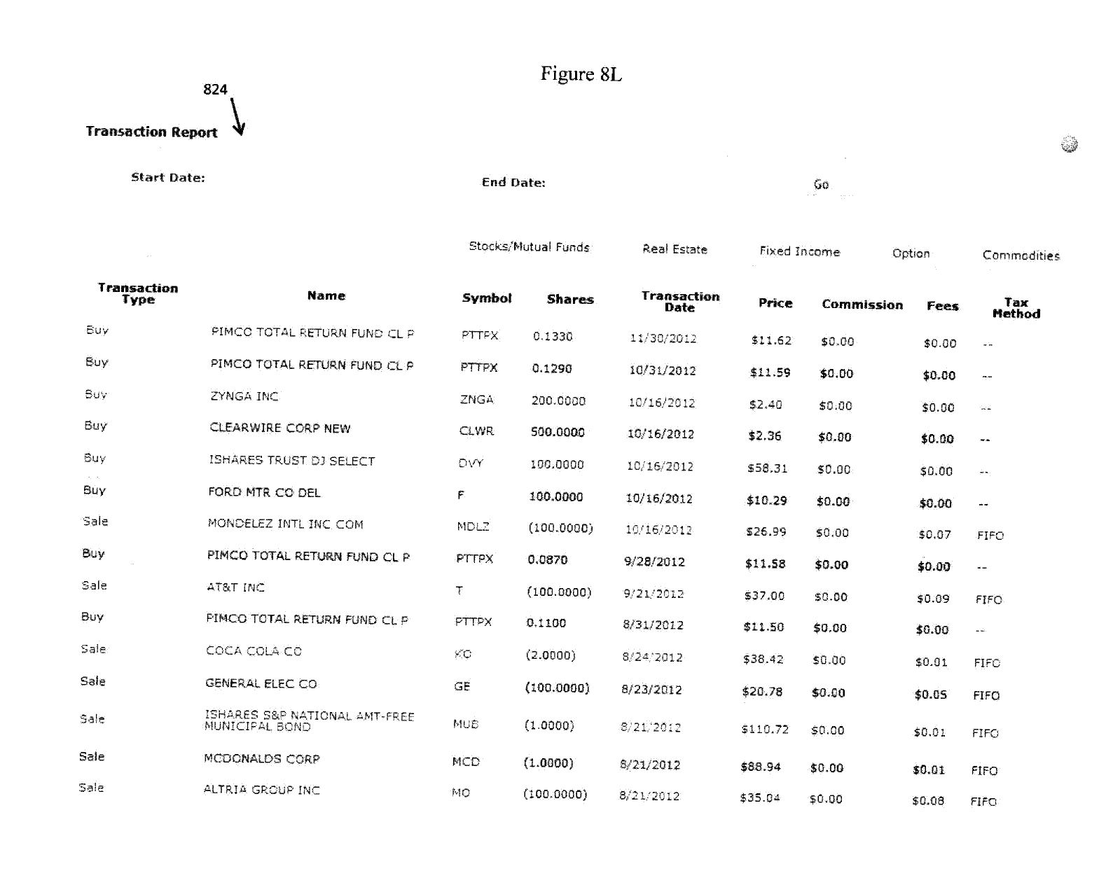

In some embodiments, the financial advisory system 100 may comprise a report module 118. The report module 118 may comprise a report made using the asset data 108 and/or the analysis performed by the cost basis engine 114 and/or the asset allocation engine 112, and or the performance engine 122. For example, the report module 118 may comprise tax reports, reports relating to changes in asset value, dividend reports, and investment performance reports, as further discussed below with respect to FIGS. 8A-L.

In one embodiment, according to various aspects of the present invention, the financial advisory system 100 may display the asset to be sold to achieve the financial goals input by the user 102 on a display 120. In one embodiment, the display 120 may indicate the allocation of asset class, industry segment, and/or sector of the assets from asset data 108. The display 120 may indicate the current allocation of assets, the target allocation of assets and value information, as is shown in FIGS. 10A and 10B.

The financial advisory system 100 is a web-based portfolio application that adjusts cost basis on stocks and mutual funds imported into the application. The financial advisory system 100 tracks cost basis on covered securities as well as historical cost basis on uncovered securities. The financial advisory system 100 displays accurate gain/loss snapshots, produces an array of dynamic reports, prepares Schedule D and 8949 Forms, alerts user of relevant market changes, consolidates multiple accounts into one centralized platform and measures assets performance against appropriate market indices.

The financial advisory system 100 will accept the following asset types: Stock, Option, Mutual Fund, Fixed Income, Commodity, Cash, Annuities, Real Estate and Other. The financial advisory system 100 can adjust the cost basis on the security/asset, namely, stocks, options, mutual funds, fixed income securities, annuities, and the like via the cost basis engine 114. The financial advisory system 100 may also utilize the asset data 108 to calculate market valuations and assess and/or evaluate investment performance of the assets and securities in the user's portfolio via the performance engine 122. In addition the financial advisory system 100 allows the user to calculate the above for all the user portfolios and accounts. For example, the financial advisory system 100 via the cost basis engine 114 calculates adjusted cost basis on stocks and mutual funds in the following manner: financial advisory system 100 collects asset data 108, such as, for example, trade log information imported by user 102 and/or from any other source, such as, any suitable repository database containing information about the asset and stores the asset data 108/information in the database 106. This asset data 108 information contains transaction history such as buys/sells for each security/asset. The financial advisory system 100 via the cost basis engine 114 utilizes cost basis algorithms to calculate the trade data of the security/asset against financial advisory system 100 corporate action data stored in the database 106 and adjusts the cost basis quantity of shares owned for capital events such as stocks splits, stock dividends, dividends, stock mergers, cash mergers, bankruptcies, stock and cash mergers, spin-offs and return of capital. Using the original purchase value of a security/asset, the financial advisory system 100 via the performance engine 122 adjusts that value of the security/asset based on the corporate action event that occurs. The adjusted cost basis may be stored in the database 106 of the financial advisory system 100 and is used by the performance engine 122 to calculate accurate gains/losses. The performance engine 122 calculates the gain/loss by taking the quantity of shares sold and sale proceeds from the trade log/asset history and applies to the tax lots using a sale methodology designated by the user. The sale methodologies may include the following accounting methods: FIFO (first in first out), HIFO (highest in first out), LIFO (last in first out) or LOFO (lowest in first out.) The default method for this is FIFO (the standard accounting method designated by the broker). Based on the sale methodology, the gain/loss may have different outcomes and therefore different tax implications. The financial advisory system 100 has the capability to run all four sales methodologies on any given sale.

The financial advisory system 100 may accept information/asset data 108 via an open financial exchange (“OFX”) file on the major brokerage accounts as the main form of user 102 communication via an application program interface (“API”). The API is a software application that transfers data and information between the designations in the financial advisory system 100. For example, the API may allow the financial advisory system 100 to communicate with a third-party database where trade activity may be stored to update the database 106. The financial advisory system 100 may also accepts a manual upload of security information in various ways, such as, for example, by excel upload or by manual addition within the graphical user interface 104. The financial advisory system 100 may use the user 102 information to match the CUSIP/ticker (security symbol) to the CUSIP/tickers that are maintained in the database 106. When a match is found, a cost basis can be calculated via the cost basis engine 114 via the API of the financial advisory system 100. For example, the API may transfer asset data 108 and any other information between the database 106, the cost basis engine 114, asset allocation engine 112, the tax optimization system 116, and the performance engine 122.

The financial advisory system 100 may require specific information, such as, for example a valid CUSIP/ticker symbol, a transaction type (such as: buys, sells, short sales, covered short sales, deposits, withdrawals), a date of transactions and a quantity of shares for the cost basis engine 114 to perform a cost basis calculation. With the information imported or provided by the user, the performance engine 122 of the financial advisory system 100 can match the CUSIP/ticker; apply price information (for fair market value, dividend calculations, corporate action calculations, cash in lieu and cost basis {Note: the financial advisory system 100 uses the average of the high and low on given market day}); and apply corporate action information (such as: stock mergers, cash mergers, stock and cash mergers, dividends, spin offs, return of capital, stock splits, stock dividends, name changes, CUSIP changes, ticker changes, bankruptcies, de-listings and liquidations) to calculate market valuations and assess and/or evaluate investment performance of the assets and securities in the user's portfolio. The financial advisory system 100 via the cost basis engine 114 utilizes the API to store cost basis algorithms, which use the asset data 108 provided from user 102 or contained in the database 106 and matched with imported data/information to calculate adjusted cost basis on securities.

In one embodiment, the financial advisory system 100 may comprise a “my” profile module, a dashboard module, a tools module, and a reports module. The dashboard module may comprise an asset allocation portion, an investment overview portion, an active wash sale portion, and an account performance portion.

The asset allocation is shown in FIGS. 10A and 10B. The asset allocation feature apportions the portfolio's assets and displays a comparison between the actual allocation and that of the target allocation. The target allocation is a personal reference based on the tolerance for risk that was determined in risk assessment questionnaire 300, as will be discussed in detail below. The target allocation can be used as a goal to develop a portfolio strategy.

An investment overview, shown in FIG. 10A, displays all asset categories and may be divided by two tabs, open positions and closed positions. The open positions tab represents current values on all unrealized holdings displayed by asset categories. The closed positions tab represents realized values on all holdings sold within the account. The categories can be clicked on and drilled down to the holding level.

An active wash sales portion, shown in FIG. 10B, lists various securities that carry a potential wash sale threat if the security is repurchased before the expiration date displayed (Typically 30 days). A wash sale is a sale of a security at a loss, where the security is then repurchased within 60 days before or after the sale. If a wash sale occurs, the amount of the loss must be deferred as an addition to cost basis on the oldest remaining tax lot. The financial advisory system 100 via the performance engine 122 calculates and tracks the investment performance of the assets/securities and warns the user of potential wash sale transactions. Each type of wash sale scenario is built into the API of the financial advisory system 100. When a wash sale occurs, the financial advisory system 100 identifies the wash sale, calculates the loss, and applies the loss amount as a deferral to the cost basis. The function of the active wash sales portion is to forewarn user of a potential wash sale violation. If the financial advisory system 100 detects a sale of a security resulting in a loss, the financial advisory system 100 will display that sale as a reminder to the user not to repurchase that security until the wash sale period expires (30 days after sale). The active wash sales portion is a helpful tool for accounts that have automatic repurchasing of stock such as an employee stock purchase plan (“ESPP”).

The ESPP utilizes the financial advisory system 100 platform, but has a limited view. A users of the financial advisory system 100 for an ESPP may import asset data 108 relating to the ESPP via the API. The users of the financial advisory system 100 for an ESPP typically do not have allocation summaries since the ESPP is usually typically utilized to manage only one investment, therefore the plurality of investment tools does not apply. The financial advisory system 100 for an ESPP may calculate basis and wash sales, tracks corporate events, and runs all the same reporting and tax forms as the financial advisory system 100 discuss herein.

An account performance portion, shown in FIG. 10B, measures the user/asset owner's investment performance divided by asset category using a time-weighted rate of return. The investment performance is benchmarked against relevant market indices for comparison. The investment performance may be calculated in month, last quarter, year-to-date and last 12 month's intervals. The investment performance may include a category, current allocation percentage, current FMV, actual return, benchmark type and index return.

Referring now to FIGS. 10A and 10B, in one embodiment, the asset allocation engine 112 may present the existing asset allocation scheme and/or the target asset allocation model the display 120 within the financial advisory system 100. The asset allocation display may show a category of assets that the assets in the existing asset allocation scheme and/or the target asset allocation model belong. For example, the category of assets may be equity. The equity may represent ownership in any asset after debts are subtracted, such as the value of a security less any funds borrowed from the brokerage on a margin account. The category of assets may also comprise fixed-income assets, such as bonds, real estate, commodities, and/or cash including and cash equivalents such as money market funds.

In another embodiment, not shown, the user 102 may view the percentage of assets in the existing asset allocation scheme and/or the target asset allocation model in each economic sector such as cyclical consumer goods, non-cyclical consumer goods, financial services, technology, and services. The user 102 may also view the asset class; referring to features of the equity such as market capitalization value (the product of the number of a company's shares outstanding by the stock price per share). For example, as shown in FIG. 10B, the user 102 may select to see the allocation of assets in the existing asset allocation scheme and/or the target asset allocation model in large capitalization (large cap) stocks and/or small capitalization (small cap). The user 102 may also select to see the allocation of assets in international stocks, fixed income, real estate, commodities, and cash.

In an exemplary embodiment of the present invention, shown in FIG. 10B, the asset allocation display may show a current allocation of assets as a percentage of assets in the asset data 108 that fall into each category of assets. The current allocation of assets may represent the existing asset allocation scheme of the asset data 108, as determined by the asset allocation engine 112. In one embodiment, the asset allocation display may also present a current fair market value (FMV) of the assets in each category of assets for the current allocation of assets. This information may give the user 102 a clear picture of the breakdown of assets in the asset data 108 that belong to each category of assets. For example, the user 102 may see that the assets in the asset data 108 may be heavily weighted in one type of category of assets and only moderately represented in others.

In an exemplary embodiment of the present invention, shown in FIG. 10A, the asset allocation display may show a target allocation percent that may represent the percentage of assets in each category of assets. The target allocation percent may represent the target asset allocation model generated by the asset allocation engine 112. In one embodiment, the asset allocation display may also present a target amount of the assets in each category of assets for the target allocation percent. For example, the target amount may represent a value, such as a dollar amount, of the assets in each category of assets. In one embodiment, by comparing the target amount to the current FMV, the asset allocation display may present an adjustment amount or target allocation in FIG. 10A.

This information may give the user 102 a clear picture of the change that may need to be made to the existing asset allocation scheme to match the breakdown of the category of assets in the target asset allocation model. For example, the user 102 may see that the adjustment amount for the fixed-income category of assets may be “−$10,000” indicating that $10,000 of assets in that category of assets should be sold. In another example, the adjustment amount for equity may be “$15,000” indicating that $15,000 in that category of assets should be purchased. The adjustment amount may give a relatively precise indicator of the action the user 102 may take to modify the existing asset allocation scheme to match the allocation of assets in the target asset allocation model.

In one embodiment, not shown, according to various aspects of the present invention, the user 102 may modify the values in the target allocation percent and/or the target amount, such as by selecting the radio button for edit target allocation portfolio. The user 102 may then manually modify the values and save the new values to the database 106 by selecting the save target button.

The my profile/user profile module 200 allows a user to import new accounts. The user can upload up to 10 accounts into one portfolio. The account information section allows a user to update their account login information such as the username, first and last name and email address. The security information section allows a user to change the password for their financial advisory system 100 login. A tax professional access section allows a user to add tax professional “read-only” access to an account. A consolidated account allows the user to combine two or more of accounts into one dashboard. These consolidated accounts allow the financial advisory system 100 calculate wash sale alerts and create reports, tax forms, and tax optimization information for planning of sales of assets. All of these sections of the my profile portion 200 of the financial advisory system 100 will be discussed in detail below.

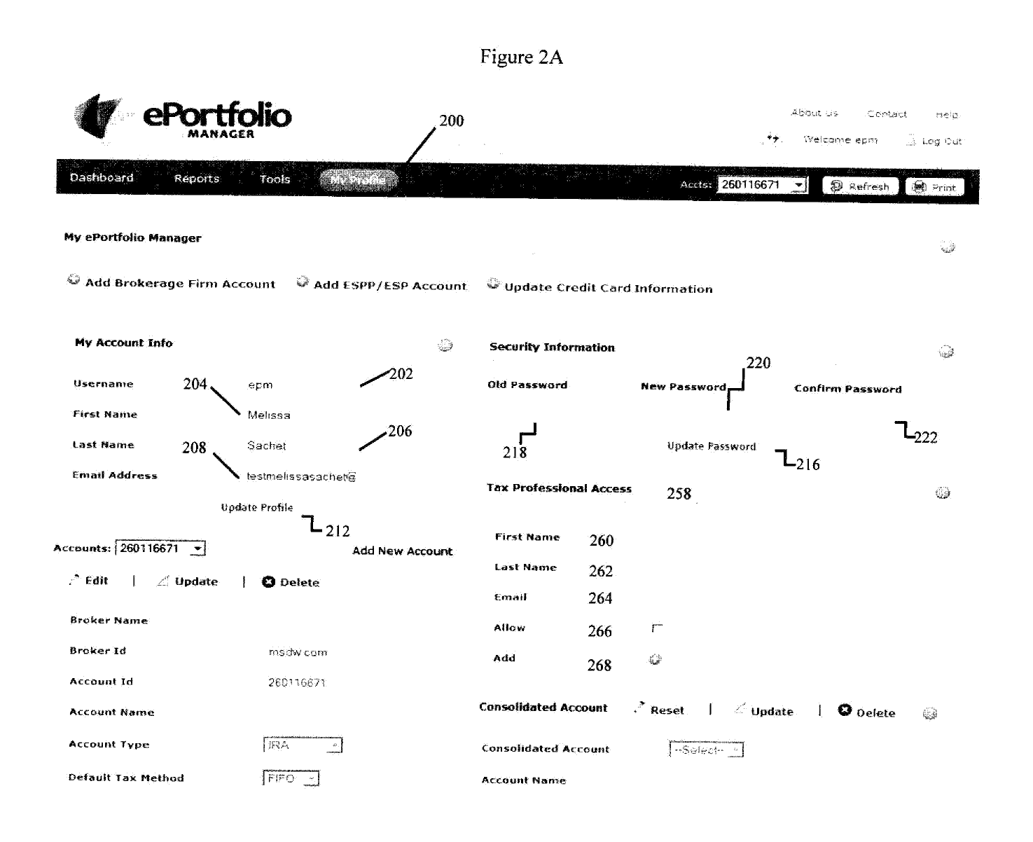

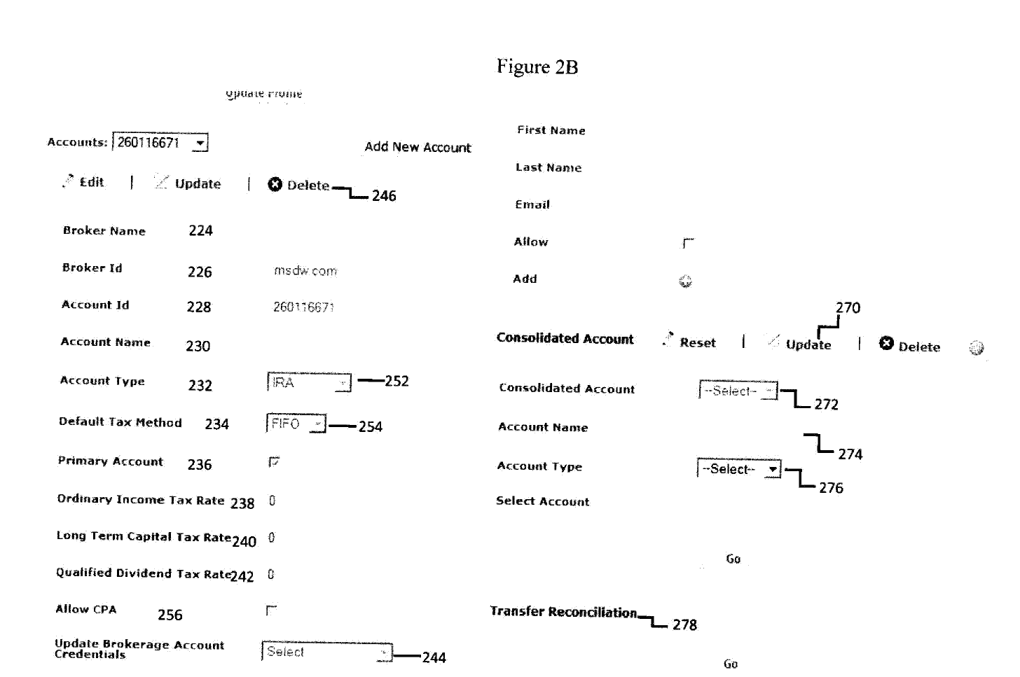

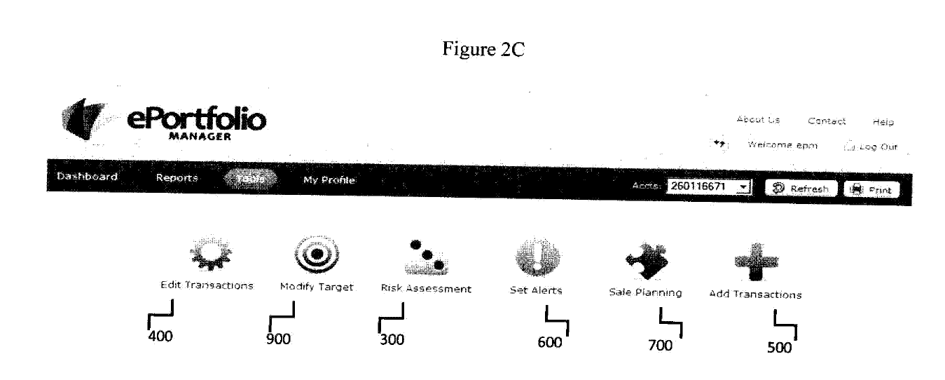

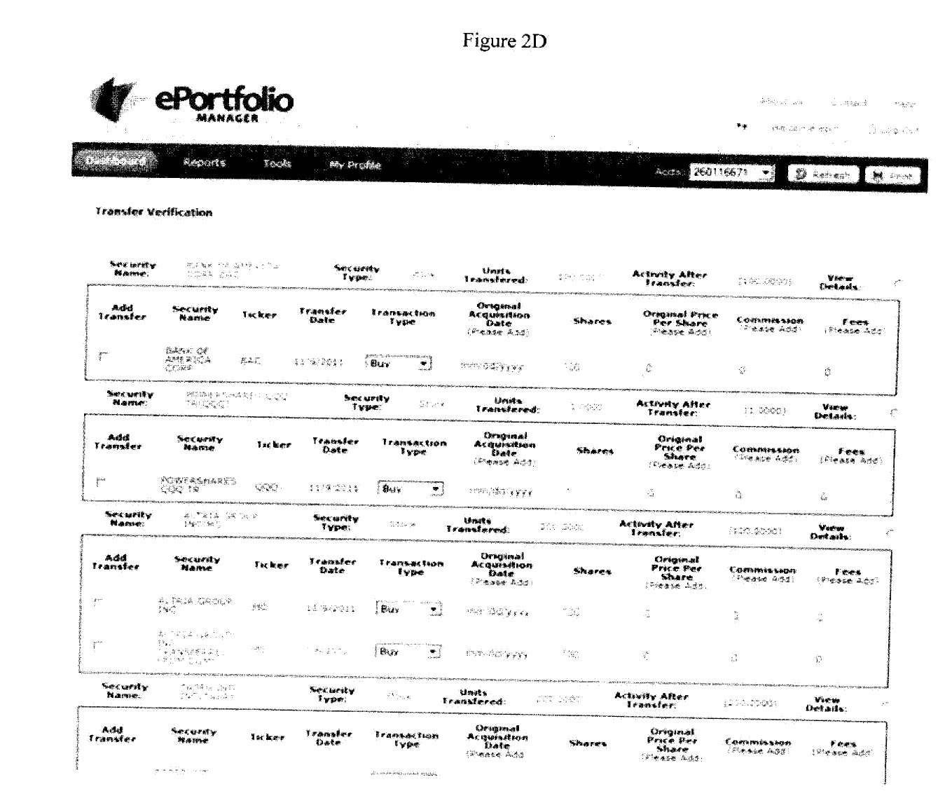

In some embodiments, referring to FIGS. 2A and 2B, the user 102 may manage different accounts within the financial advisory system 100 in a my profile or user profile module 200. The user 102 may access the user profile module 200 and any other module and/or displays of the financial advisory system 100 through the graphical user interface 104. Referring to FIG. 2A, the user 102 may enter identifying information in a personal profile/my account info section by entering a username 202, first name 204, last name 206, and/or email address 208. The user 102 may save the personal profile to the database 106 by selecting an update profile button 212. In the event that the profile information changes, the user 102 may enter new personal profile information and then select the update profile button 212 to save the new information to the database 106.

The user 102 may change a password in the security information section to securely access the financial advisory system 100 by entering an old password 218, a new password 220, and enter the new password 220 again in confirm password 222. The user 102 may select the update password button 216 to save the new password 220 to the database 106.

The user 102 may identify information for one or more accounts at various investment brokerage firms. For example, referring to FIG. 2B, the user 102 may designate information for an account. The user 102 may have any number of accounts. In one embodiment, each account may be edited or deleted 246 according to changes needed by the user 102. For each account, the user 102 may enter a broker name 224 and/or a broker identification symbol 226. The user 102 may also designate an account name 230 and/or an account identifier 228 for distinguishing between the accounts at the same brokerage firm. In one embodiment, the user 102 may designate the account type 232 such as an individual account, a corporate account, a limited partnership account, and/or an account with a purpose such as a custodial account or college account and the like. For example, the account type 232 may comprise an account type drop down menu 252 with multiple options. The possible responses may include, but are not limited to individual, joint, trust, corporate, individual retirement account (“IRA”), and Roth IRA.

In some embodiments, the user 102 may designate a default tax method 234 that may apply to each account 210. For example, the default tax method 234 may comprise a tax method drop down menu 254 with multiple options. In one embodiment, the default tax method 234 may comprise a first in first out (FIFO) option, where the first tax lots purchased by date would be sold first. In another embodiment the default tax method 234 may comprise a last in first out (LIFO) option, where the last tax lots purchased by date would be chosen. In another embodiment, the default tax method 234 may comprise a specific option, where the user 102 can specifically choose the tax lots and/or sort the tax lots as desired. In another embodiment, the default tax method 234 may comprise an average single option, where the short-term and long-term tax lots are combined. In another embodiment, the default tax method 234 may comprise an average double option, where short-term tax lots are averaged and long-term tax lots are averaged and presented separately. In another embodiment, the default tax method 234 may be a highest first out (HIFO) option, where the highest cost basis tax lots are sold first. In yet another embodiment, the default tax method 234 may comprise a lowest first out (LOFO) option, where the lowest cost basis tax lots are sold first. In another embodiment, the default tax method 234 may comprise an all option where each of the above options is chosen. In another embodiment, the user may choose which of the above specific sales methodology to apply to the tax lots that were sold.

In some embodiments, the user 102 may further select whether each account name 230 is a primary account 236. For example, the primary account 236 may be an account that has the largest value and/or the account the asset owner uses regularly. In one embodiment, the primary account 236 may be a user's household account. In one embodiment, the primary account 236 may be a user's business account.

In some embodiments, according to various aspects of the present invention, the user 102 may further indicate various designated tax rates on each account, such as an ordinary income tax rate 238, a long-term capital tax rate 240, and/or a qualified dividend tax rate 242. The tax rate information may be used by the tax optimization system 116 to calculate the tax in the event an asset from the account name 230 is sold.

In some embodiments, the user 102 may select whether a professional, such as, for example, a CPA or Financial Advisor, should have access to the information. To select this option the user 102 may select allow CPA 256. When the user chooses to allow CPA 256, the user can then input CPA information 258 in the tax professional access portion. The CPA information 258 may comprise a first name 260, a last name 262, and an email address 264. The user 102 can then check the allow box 266 and select add 268 and a CPA will have access to the user's 102 account. For example, an individual investor/user 2 may import information and asset data 102 into the financial advisory system 100 with their own login credentials, as discussed above. The individual investor/user 2 may allow the professional access within the graphic user interface 104 and the professional may search for their client by invitation or email and add them to their CRM. The professional may have a professional view of the financial advisory system 100, meaning that they can see everything the individual/user can see, but with “read only” access. The financial advisory system 100 provides the professional with a database of his/her client's information that is viewed only in the professional's version of the system. The database interfaces all their clients, all their client's accounts and all their client's consolidated accounts for the professional view. The professional view may comprise a dual view of the financial advisory system 100 in which they can view with “read only” access multiple clients and multiple clients' accounts. The professional would not have secured access to import or change any of the client/user's information, but the professional may utilize the financial advisory system 100 to run tax optimization, cost basis, sale planning scenarios, set the target allocation, view information, such as, asset data 108, and print reports, such as, the tax forms and tax estimates, all of which are described herein.

In some embodiments, the user 102 may enter brokerage account credentials 244 to track and update the qualifications of each brokerage firm. In one embodiment the brokerage account credentials 244 may comprise security and password details. In one embodiment, the brokerage account credentials 244 may comprise accreditations with the Accredited Estate Planner (AEP), Accredited Tax Advisor (ATA), Accredited Tax Preparer (ATP), Certified Annuity Advisor (CAA), Chartered Financial Analysts (CFA), Certified Fund Specialists (CFS), Investment Management Consultants Association (CIMA), and/or any one of a wide variety of credentials a financial advisor may obtain.

The user 102 may also elect to consolidate accounts 270 from a drop down menu 272. The user 102 may also enter the account name 274 and account type 276 to consolidate. The consolidate accounts 270 allows two or more accounts to be combined into one dashboard. The user 102 may reset, update, and/or delete the consolidated accounts by selecting the appropriate option. The accounts can be one single users' account or multiple users' accounts.

The user may also perform a “transfer reconciliation” 278 if a transfer occurs prior to the user being setup in the financial advisory system 100. If a transfer of accounts such as an ACAT or merger occurred, the cost must be captured or re-entered to ensure accuracy. Within the OFX, the financial advisory system 100 will detect transfer events and display the Transfer Verification, as shown in FIG. 2D, which may comprise a display screen with input fields for the required information such as date of original purchase and price of original purchase. If this information is included in the brokerage transfer then it will automatically populate.

In some embodiments the financial advisory system 100 may comprise an asset data upload module. In one embodiment, the user 102 may enter asset data 108 in the asset data upload module to be saved in the database 106 within the financial advisory system 100. In one embodiment, the user 102 may import asset data 108 in the asset data upload module to be saved in the database 106 within the financial advisory system 100. Any electronic file comprising financial data may be entered or imported into the asset data upload module. For example, the OFX file may be selected to be uploaded into the asset data upload module. The OFX file may comprise an open standard unified specification for the exchange of electronic financial data between financial software programs, financial institutions, and businesses. In one embodiment, the OFX file may be created in a financial program such as Google Finance, Quicken, and/or Microsoft Money software and the like. In one embodiment, the user 102 may select the electronic file containing the asset data 108 by searching for the file from any source storing the file, such as a hard drive, USB device, and/or internet source and the like.

In some embodiments, as shown in FIG. 2C, the financial advisory system 100 may comprise a tools module. The tools module may comprise a risk assessment module 300 an edit transaction module 400, an asset data manager module 500, an alert module 600, a sale planning module 700 and a modify target module 900.

The Edit Transactions tool allows a user to modify or delete transactions. This section is divided by six tabs: Stocks, Fixed Income, Real Estate, Options, Commodities, and Mutual Funds. A user may select the tab that represents the category for edit. The edit transactions is described in detail below in an edit transaction module 400.

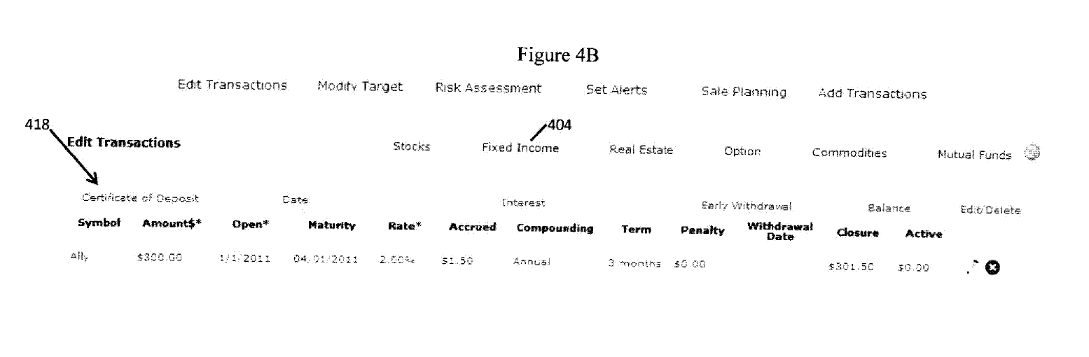

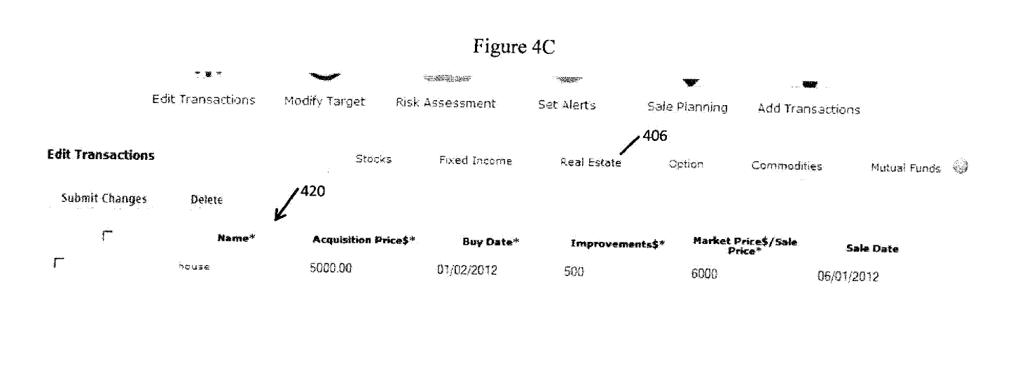

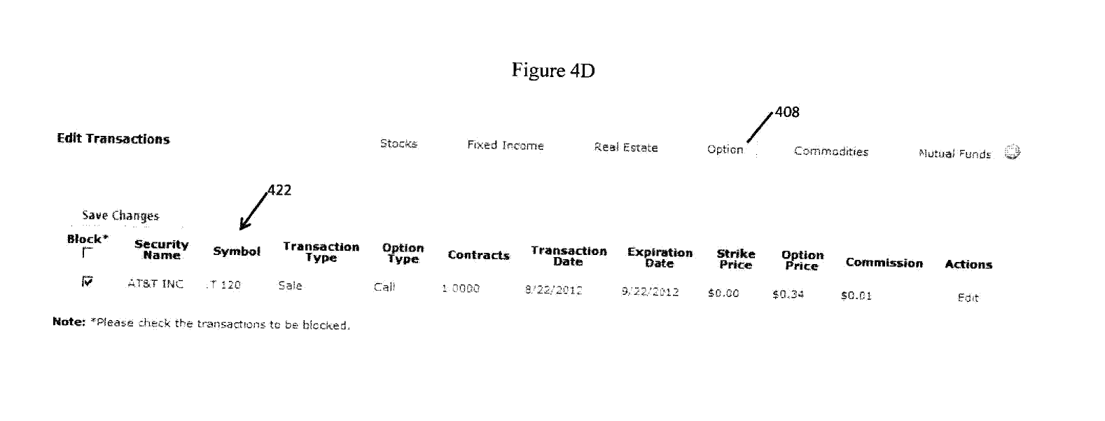

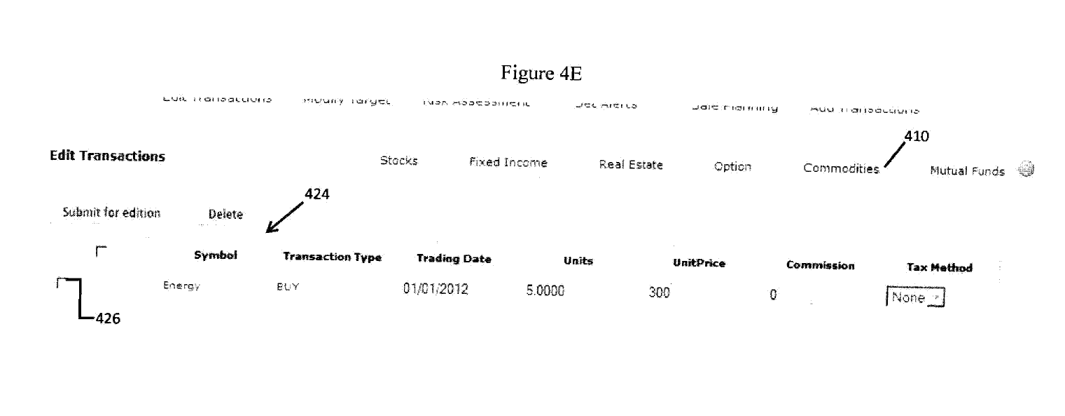

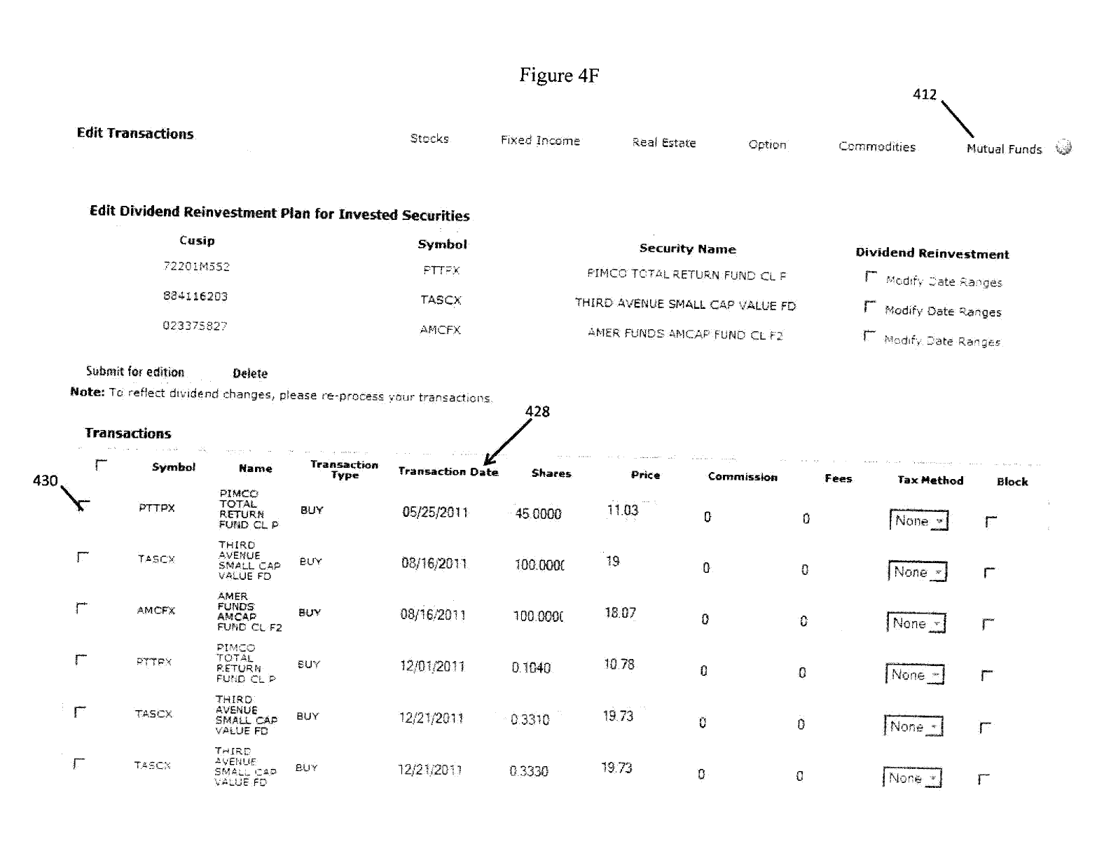

In some embodiments, the tools module of the financial advisory system 100 may comprise an edit transaction module 400. In one embodiment, the asset data 108 entered into the asset data upload module may be edited in the edit transaction module 400 within the financial advisory system 100. The edit transaction module 400 may allow the user 102 to edit the specific data relating to asset data 108 from the asset data manager module 500. In one embodiment, referring to FIGS. 4A-4E, the edit transaction module 400 may display a stock module 402, fixed income module 404, a real estate module 406, an options module 408, a mutual funds module 412, and a commodities module 410 for the user 102 to edit.

In some embodiments, the user 102 may edit specific data relating to asset data 108 into the edit transaction module 400 to be saved in the database 106. Referring to FIG. 4A, the user may edit stock information 414 in the stock module 402. The stock information 414 may comprise a stock symbol, a stock name, a transaction type, a transaction date, number of shares, share price, commission, fees and tax method. The tax method may comprise FIFO, LIFO, HIFO, and LOFO as described in detail above. The user 102 may check a box 416, to edit the stock information 414. Once the user 102 has edited the stock information 414, the user 102 may select the submit changes button. Alternatively, the user 102 may delete the stock information 414 by selecting the delete button.

Referring to FIG. 4B, the user 102 may edit fixed income information 418 in the fixed income module 404. Fixed income may include but is not limited to government bonds, corporate bonds, municipal bonds, and certificates of deposits. When the user 102 enters the fixed income module 404, the user 102 will be able to view any CD or fixed income currently in the account to select and edit the fixed income information 418. The fixed income information may comprise a stock symbol, an amount, an open date, a maturity date, an interest rate, interest accrual, compounding term, term, early withdrawal penalty, withdrawal date, closure balance, and active balance.

Referring to FIG. 4C, the user 102 may edit real estate information 420 in the real estate module 406. The real estate information 420 may comprise a name, an acquisition price, a buy date, improvements, market price or sale price, and sale date. The user 102 may check the edit the real estate information 420 and submit the changes or delete for the desired action.

Referring to FIG. 4D, the user 102 may edit option information 422 in the option module 408. The option information 422 may comprise a security name, a symbol, a transaction type, an option type, contract, a transaction date, an expiration date, a strike price, an option price, and a commission. The user 102 may edit the option information 422 and save the changes.

Referring to FIG. 4E, the user 102 may edit commodities information 424 in the commodities module 410. The commodities information 424 may comprise a commodities symbol, a transaction type, a trade date, number of units, unit price, commission, and tax method. The tax method may comprise a drop down menu with the options of FIFO, LIFO, HIFO, and LOFO, as described in detail above. The user 102 may check a box 426 to edit the commodities information 424. Once the user 102 has edited the commodities information 424, the user 102 may select to submit for addition. Alternatively, the user 102 may delete the commodities information 424 by selecting delete.

Referring to FIG. 4F, the user 102 may edit mutual fund information 428 in the mutual fund module 412. The mutual fund information 428 may comprise a mutual fund symbol, a mutual fund name, a transaction type, a trading date, number of shares, share price, commission, fees and tax method. The tax method may comprise a drop down menu with the options of FIFO, LIFO, HIFO, and LOFO, as described in detail above. The user 102 may check box 430 to edit the mutual fund information 428. Once the user 102 has edited the mutual fund information 428, the user 102 may select the “submit button” for addition changes button. Alternatively, the user 102 may delete the mutual fund information 428 by selecting the delete button.

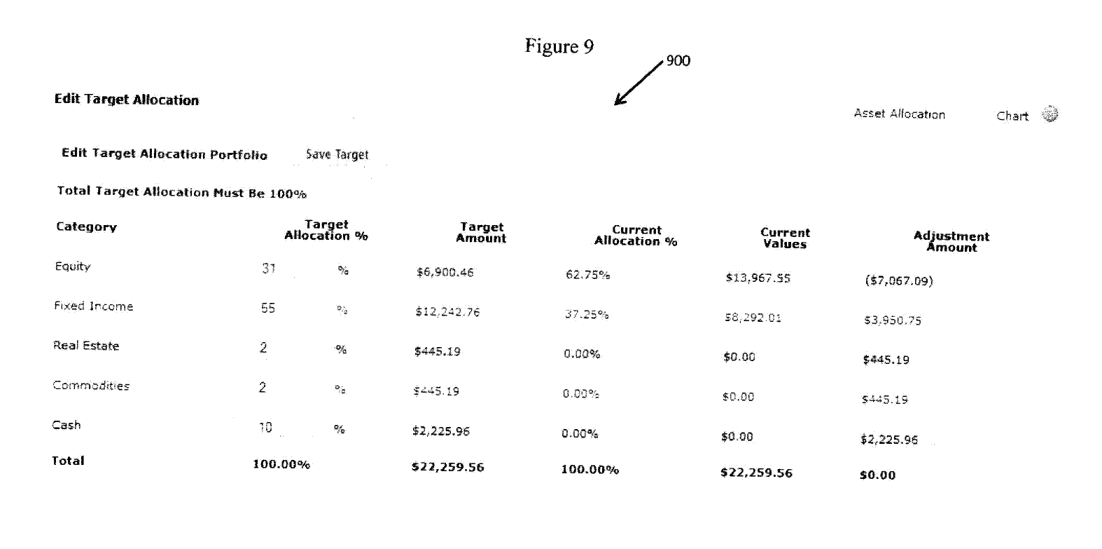

Referring now to FIG. 9 the modify target module 900 tool allows the user 102 to adjust the target allocation percentages manually. In the event that the risk assessment questionnaire, discussed below, did not result in the desired target, a user can use this tool to edit the asset category proportions. The modify target module 900 may comprise a category, a target allocation percent, a target amount, a current allocation percent, a current value, and an adjustment amount. The category shows the assets, i.e., equity, fixed income, real estate, commodities, cash, etc., in the user's 102 portfolio. The user 102 can modify the target allocation percentages and then save the target. By saving or selecting a target, the asset allocation engine generates a new target portfolio allocation model for the user to set. Once set, the user can buy or sell securities to meet the new target portfolio. An example may be to reach a larger target for equities of 20%, the asset allocation engine will suggest to purchase additional equities.

The risk assessment questionnaire helps a user to determine their attitude toward risk as an investor. Based on the answers, the financial advisory system 100 can assess risk tolerance and help the user build a portfolio strategy. This portion is discussed in detail below where risk assessment module 300 is described.

In some embodiments the tools module may comprise the risk assessment module 300. In one embodiment, referring to FIGS. 3A-3B, the user 102 may enter the asset owner's preferences related to risk tolerance and/or financial goals in the risk assessment module 300 within the financial advisory system 100. The risk assessment module 300 may comprise any questions related to the assets owner's attitude toward economic trends, tolerance for gain and/or loss in asset value, and/or the asset owner's financial strategy in terms of time to retirement, age, income sources and the like. The information entered into the risk assessment module 300 may be analyzed by the asset allocation engine 112 to generate a target asset allocation model based on the asset owner's preferences, as described in detail below.

In some embodiments, the risk assessment module 300 may comprise various questions for the user 102 to answer. For example, in an exemplary embodiment, the user 102 may enter information the asset owner's attitude about the U.S. economy 302. The user may enter this response via a drop down menu 304. The possible responses may include, but are not limited to very negative, somewhat negative, neutral, somewhat positive, and very positive. The risk assessment module 300 may also comprise questions about the time frame in which the asset owner prefers to meet a financial goal 306. The user may enter this response via a drop down menu 322. The possible responses may include, but are not limited to 1 to 3 years, 3 to 5 years, 5 to 10 years, 10 to 15 years, and more than 15 years. The risk assessment module 300 may also comprise questions about the stability of income sources 308 of the asset owner. The user may enter this response via a drop down menu 324. The possible responses may include, but are not limited to very unstable, unstable, somewhat stable, stable, and very stable. The risk assessment module 300 may also comprise questions about whether the asset owner believes his or her income will keep pace with inflation 310. The user may enter this response via a drop down menu 326. The possible responses may include, but are not limited to decrease, keep pace, and increase. The risk assessment module 300 may also comprise questions about how conservatively or aggressively the asset owner would want assets invested if a professional money manager had complete discretion over the asset owner's portfolio 312. The user may enter this response via a drop down menu 328. The possible responses may include, but are not limited to conservatively, moderately conservative, moderate, moderately aggressive, and aggressively.

In some embodiments, the risk assessment module 300 may comprise questions related to what action, if any; the asset owner may take in response to an event. In one embodiment, the risk assessment module 300 may comprise questions about whether the asset owner would keep or sell a stock that decreased in value substantially 314. The user may enter this response via a drop down menu 330. The possible responses may include, but are not limited to buy more of this investment, hold on to this investment, sell some of the investment, sell most of the investment, and sell all of the remaining investment. In one embodiment, the risk assessment module 300 may comprise questions about whether the asset owner would keep or sell a bond that decreased in value substantially 316. The user may enter this response via a drop down menu 332. The possible responses may include, but are not limited to buy more of this investment, hold on to this investment, sell some of the investment, sell most of the investment, and sell all of the remaining investment.

In one embodiment, the risk assessment module 300 may display examples of portfolio performances ranging in short term and long term gains and losses in value and request that the user 102 select which portfolio is within the asset owner's preferences and expectations 318. In another embodiment, the risk assessment module 300 may comprise a question about whether the asset owner is comfortable with an investment with little change in value that results in lower returns 320. The user may enter this response via a drop down menu 334. The user 102 may save the information entered into the risk assessment module 300 into the database 106 by selecting the submit button.

In some embodiments, the asset allocation engine uses variables assigned to the risk assessment module 300 to determine an appropriate allocation model (for the user), as will be discussed in detail below. Based on the results from the risk assessment module 300, the target asset allocation may be calculated. As described above, there are multiple questions 302, 306, 308, 310, 312, 314, 316, and 320 that are designed to assess the asset owner's preferences. The answers 304, 322, 324, 326, 328, 330, 332, and 334 to the questions are then evaluated to create an acceptable allocation model. The answers 304, 322, 324, 326, 328, 330, 332, and 334 to the questions are assigned quantitative values that indicate the asset owner's preferences. For example in the risk question, “In general what is your attitude towards the US Economy”, the response is assigned a numerical value: 1 for Very Negative, 2 for Somewhat Negative, 3 for Neutral, 4 for Somewhat Positive and 5 for Very Positive. The total of all the risk assessment questions is calculated and based on the total, the acceptable allocation is selected. The high the score, the more risk tolerant is the user and the lower the score, the less risk tolerant is the user.

In some embodiments, the acceptable allocation model may comprise options of a very low risk tolerance, a moderately low risk tolerance, a moderate risk tolerance, a high risk tolerance, and a very high risk tolerance. In one embodiment, when given quantities values, the very low risk tolerance may be from 1-10, the moderately low risk tolerance may be from 11-20, the moderate risk tolerance may be 21-30, the high risk tolerance may be from 31-40, and the very high risk tolerance may be from 41-50. In one embodiment, very low risk tolerance may indicate that even in bull markets, the asset owner seeks risk adverse decisions. The very low risk tolerance may be highly cautious approach an asset owner who wants liquid income and a stable investment. In one embodiment, the moderately low risk tolerance may comprise an asset owner that seeks consistent and dependable income with a modest potential for growth. In one embodiment, the moderate risk tolerance may comprise an asset owner that wishes to minimize risk with stable stocks to balance high risk stocks for long term investors with potential for growth but less volatility than the market. In one embodiment, the high risk tolerance may comprise an asset owner that is focused on long term investment with growth potential in a volatile market. In one embodiment, the very high risk tolerance may comprise an asset owner that is focused on high return long term investments.

Once the acceptable allocation model is assessed, the risk assessment module 300 along with the asset allocation engine 112 may calculate the target asset allocation.

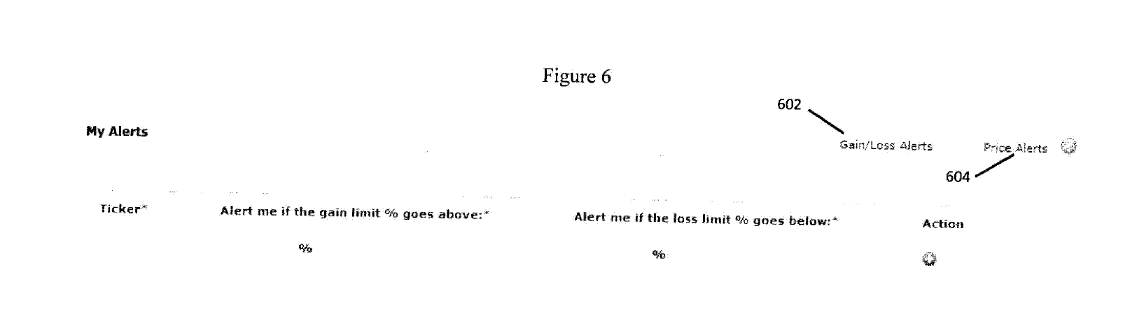

The set alerts tool 600, shown in FIG. 6, allows the user 102 to set parameters for alert notification on the securities based on a price range, or on a range for a gain/loss percentage. The feature is divided by two tabs; the gain/loss alerts tab 602 and the price alerts tab 604. The gain/loss alerts tab 602 allows the user 102 to input the ticker, and a gain limit and loss limit. The price alerts tab 604 allows the user to input the ticker and the price gain limit and price loss limit. Accordingly, once an asset reaches the gain or loss limit, the user will be alerted. Once the user 102 saves the alert, the next time the user logs in to financial advisory system 100, the active alerts will be displayed at the top of the page in an alert bubble.

The sale planning module functions to allow the user to review their potential sales using the current tax status, current gains, and/or losses in the accounts. Based on gains or losses a user may choose to sell at a gain or loss to meet their specific tax needs.

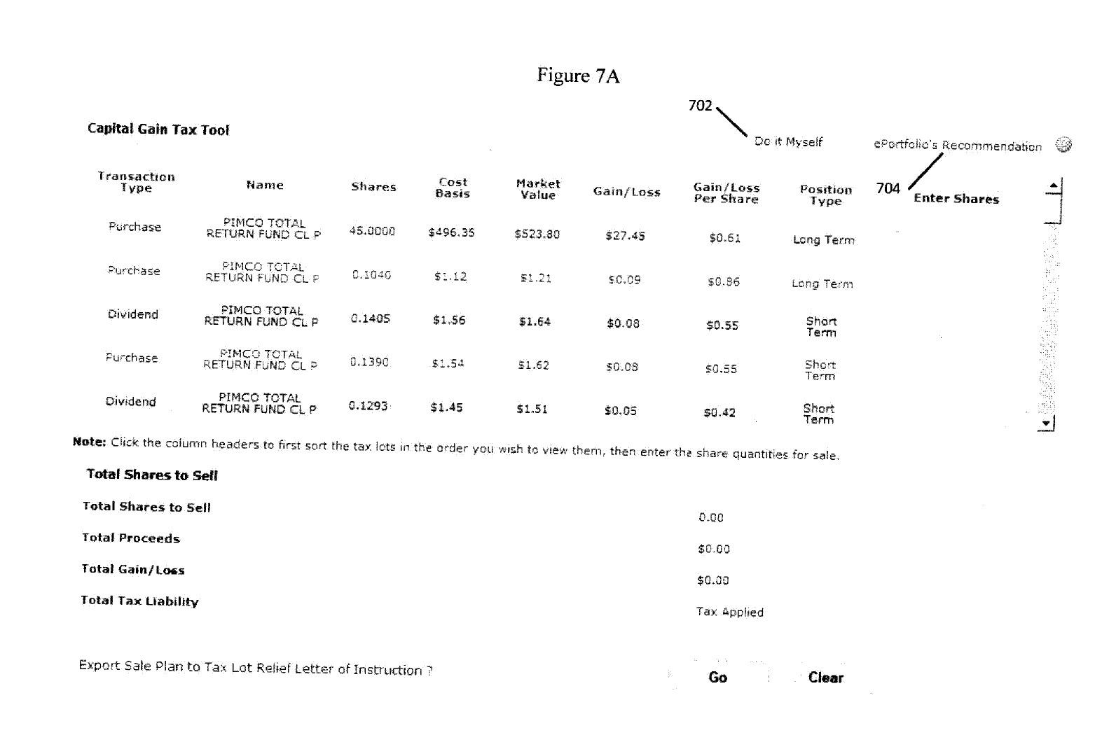

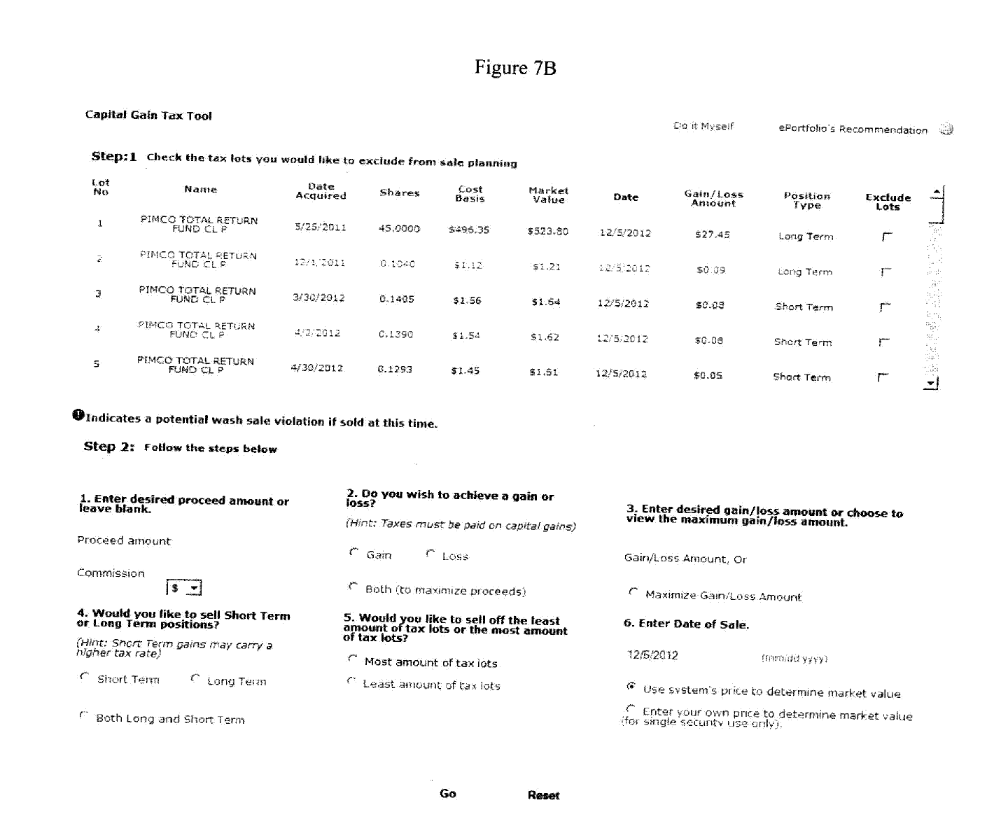

The sale planning module 700, shown in FIGS. 7A and 7B may comprise a user selection tab 702 and auto system tab 704. The user selection tab 702 allows the user 102 choose which tax lots to sell based on tax goals while the auto system tab 704 uses the financial advisory system 100 recommendation on which tax lots to sell. The purpose of this feature is to help the user 102 choose which tax lots to sell based on the user's tax goals. Each tax lot has a cost basis, calculated by the cost basis engine 114, and a gain/loss amount. The order in which the user 102 may sell these tax lots can determine the value of the overall gain/loss and therefore the amount the user 102 may owe in capital gains taxes. This feature can help the user 102 to realize their proceeds goals, while controlling their gain/loss amounts.

The user selection tab 702 shows the assets owned by the user 102. The assets may comprise a lot number, name, date acquired, number of shares, cost basis, market value, current date, gain/loss amount, and position type. The user 102 can then enter the number of shares that the user 102 wishes to sell and a disposition summary, including but not limited to total shares to sell, total proceeds, total gain/loss, and total tax liability, will be shown on the bottom of the page. If the user 102 is happy with the disposition summary, the user 102 may select the go tab and the tax lot relief letter of instruction will be generated, which can then be sent to a broker.

To use the user selection tab 702, shown in FIG. 7A, a user 102 can start by clicking the column headings to sort the tax lots in the way that they wish to view them. For example, if they are looking to sell only the tax lots that carry a loss, they can use the gain/loss or the gain/loss per share columns to group together all of the loss tax lots. Next, the user can enter the share amounts. The bottom half of the page will total the share quantity, proceeds, and the gain/loss for the shares entered. The results can be exported to the tax lot relief letter of instruction which can be emailed to a broker.

The auto system tab 704/financial advisory system 100 recommendation, shown in FIG. 7B, is a decision tool that will analyze tax goals of the user 102 and suggest which tax lots to sell based on a short questionnaire. The first step is to check an excludes lots box on the far right column to mark which tax lots to exclude from sale consideration. For example, this could be tax lots that are marked for a potential wash sale violation. The second step is to answer a set of questions to help determine the user's 102 financial goals. Once the user 102 has answered the question/questions, the user 102 may select “go” and the tax optimization engine 116 will calculate and suggest which tax lot to sell based on the user's input. The user 102 can then select which lot to sell or print out and provide to the user's investment advisor to process or execute the trades. The financial advisory system 100 can calculate ACROSS accounts for tax optimization to determine the best methods of sale in all the accounts that are consolidated in the portfolio.

The Add Transactions tool helps manage a portfolio by adding transactions to asset categories. The section may have six different tabs; stocks/mutual funds, options, fixed income, real estate, commodities and money market fund/cash.

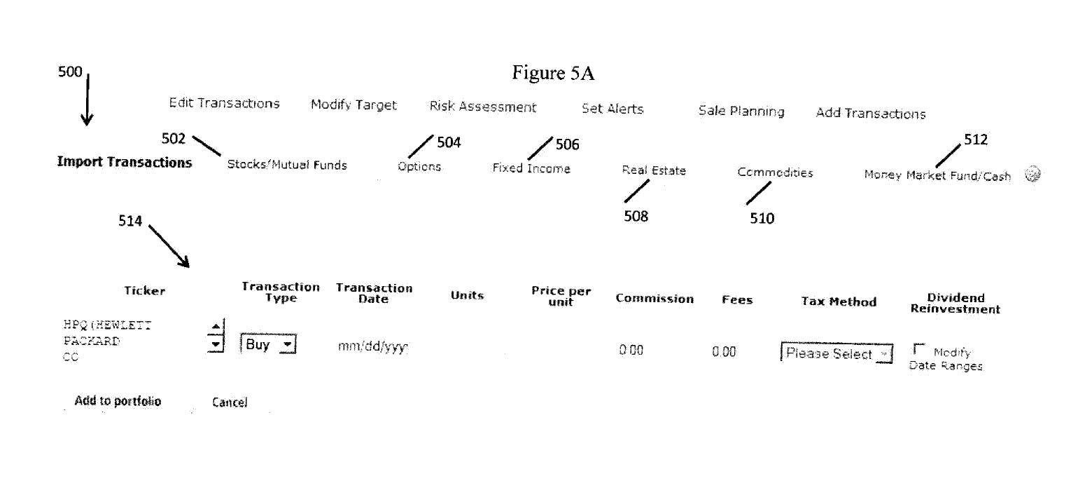

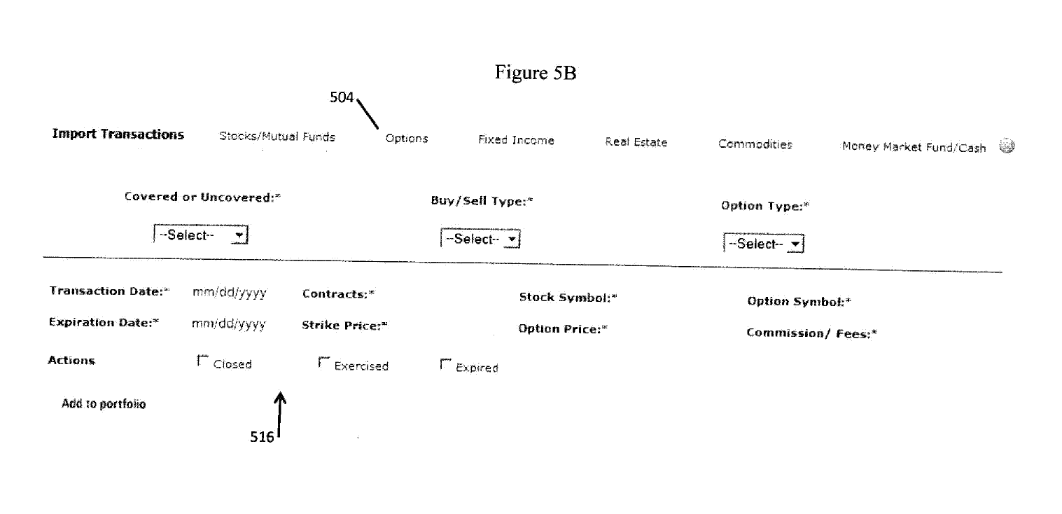

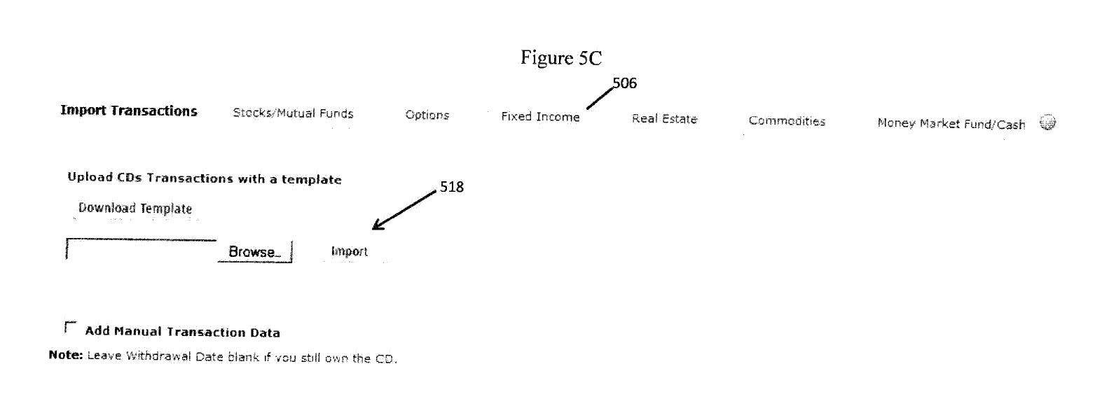

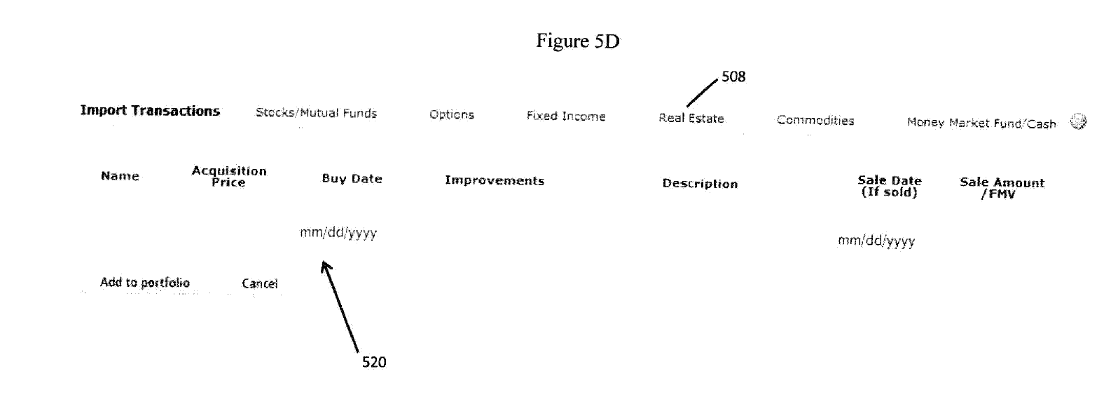

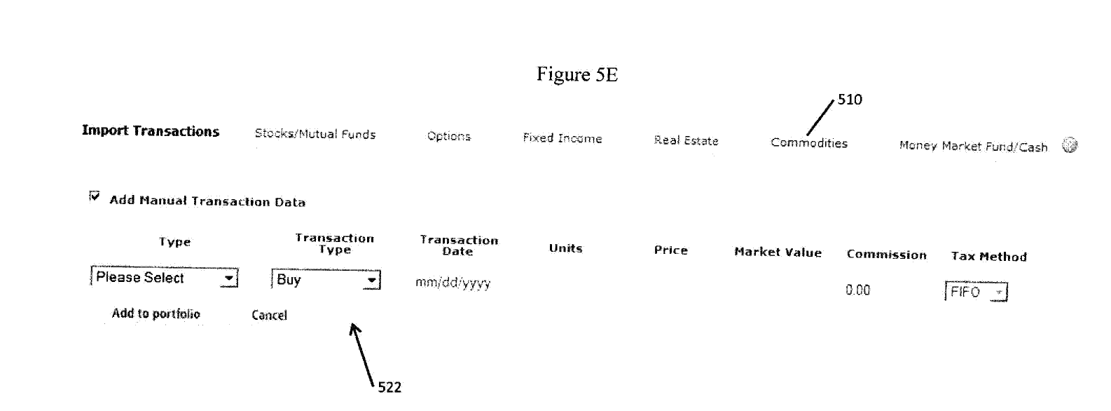

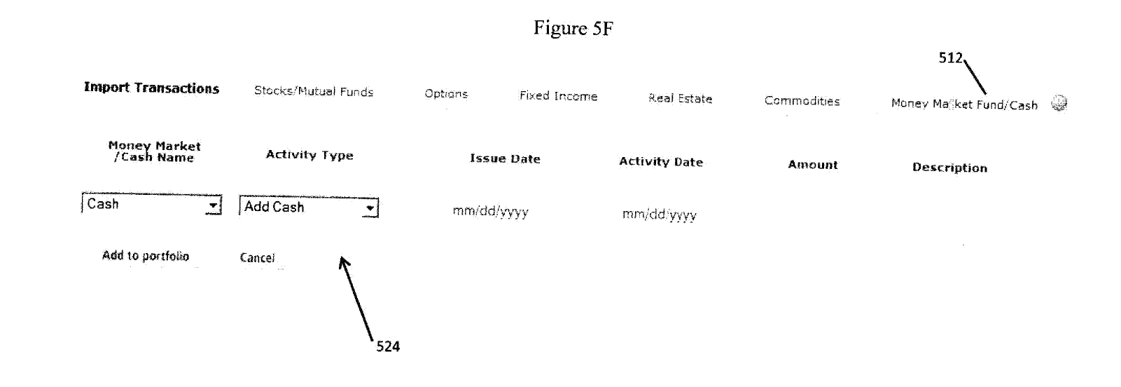

In one embodiment, the tools module may comprise the add transactions or asset data manager module 500. In one embodiment, of the present invention, the asset data 108 that may be entered by the user 102 into the asset data upload module may be sorted and viewed through the asset data manager module 500 within the financial advisory system 100. In one embodiment, the asset data manager module 500 may import asset data 108 from the asset data upload module. In some embodiments, referring to FIGS. 5A-5F, the asset data manager module 500 may comprise a stock module 502, an options module 504, a fixed income module 506, a real estate module 508, a commodities module 510, and a money mark fund/cash module 512. The stock module 502, options module 504, fixed income module 506, the real estate module 508, the commodities module 510, and the money mark fund/cash module 512 may import asset data 108 from the asset data upload module.

In some embodiments, the user 102 may enter specific data relating to asset data 108 into the add transaction/asset data manager module 500 to be saved in the database 106.

In some embodiments, referring to FIG. 5A, the user 102 may import stock information 514 in the stock module 502. In one embodiment, the user 102 may import stock information 514 from the database 106. In one embodiment, the user 102 may import stock information by searching for a stock name or a stock symbol. In some embodiments, the stock information may comprise the stock symbol or ticker, the stock name, a transaction type, a transaction date, number of units, unit price, commission, fees, and tax method. The user 102 may add to the user's portfolio by selecting the add to portfolio button or may cancel.

In some embodiments, referring to FIG. 5B, the user 102 may enter option information 516 in the option module 504 of the asset data manager module 500. The option information 516 may comprise any security identified by an option symbol and/or a stock symbol that the asset owner has the right to buy, such as through an employment or other contract. In some embodiments, the user 102 may enter the option action such as an option to buy the security (call option) or to sell the security (put option). The user 102 may also select whether the option action is closed, exercised, and/or expired. In various embodiments, the user 102 may enter the option type and whether the option is covered or uncovered. The user 102 may also enter the option price and the commission/fees if applicable. The user 102 may also enter the expiration date of the option contract. In one embodiment, the user 102 may add the strike price for the fixed price indicated in the option contract for buying or selling the security. The user 102 may select the add to portfolio button to upload the option information into the database 106.

In some embodiments, referring to FIG. 5C, the user may import fixed income information 518 in the fixed income module 506. The user 102 may browse and import the fixed income module 506 with the fixed income information 516. The user 102 may enter a portion of the fixed income information 516 to populate the fixed income module 506 with the remainder of fixed income information 516. The fixed income information 516 may comprise a name, compounding period, a term, open date, amount, interest rate, penalty, and withdrawal date. In one embodiment, the name may comprise a drop down menu comprising a security name or symbol. In one embodiment, the compounding period may comprise a drop down menu comprising the following options annual, semi-annual, quarterly, monthly, or daily. In one embodiment, the term may comprise a drop down menu comprising the following options 3 months, 6 months, 9 months, 12 months, 18 months, 3 years, 4 years or 5 years. The user may elect to add the data manually, and the user may then manually add the above fixed income information 518 to the user's portfolio.

In some embodiments, referring to FIG. 5D, the user may import real estate information 520 in the real estate module 508. The user 102 may enter a portion of the real estate information 520 to populate the real estate module 508 with the remainder of the real estate information 520. The user 102 may enter a portion of the real estate information 520 or all of the real estate information 520. In one embodiment, the user 102 may import the real estate information 520. In one embodiment, the user may manually enter the real estate information 520. The real estate information 520 may comprise a name, an acquisition price, a buy date, improvements, debt, description, sale date, and sale amount or fair market value (FMV). The FMV may comprise the current estimated value of the real estate. The user may add to the user's portfolio by selecting the add to portfolio button or may cancel.

In some embodiments, referring to FIG. 5E, the user may import commodities information 522 in the commodities module 510. The user 102 may enter a portion of the commodities information 522 to populate the commodities module 510 with the remainder of the commodities information 522. The commodities information 522 may comprise a commodities type, a transaction type, a transaction date, number of units, unit price, commission, and tax method. The commodities type may comprise a drop down menu comprising options including but not limited to agriculture, bens, energy, gold, industrial metals, livestock & meat, other, precious metals, or rare metals. The transaction type may comprise a drop down menu comprising the options of by or sell. The tax method may comprise a drop down menu comprising the following options FIFO, LIFO, HIFO, or LOFO as described in detail above. The user 102 may add to the user's portfolio by selecting the add to portfolio button or may cancel. The user 102 may also elect to manually enter the commodities information 522.

In some embodiments, referring to FIG. 5F, the user may import/enter money mark fund/cash information 524 in the money mark fund/cash module 512. The user 102 may enter a portion of the money mark fund/cash information 524 to populate the money mark fund/cash module 512 with the remainder of the money mark fund/cash information 524. The money mark fund/cash information 524 may comprise a name, an activity type, an issue date, an activity date, amount, and a description. The name may comprise a drop down menu comprising cash or money market. The activity type may comprise a drop down menu comprising the options of add cash, withdraw cash or corporate action-cash activity. The user may add to the user's portfolio by selecting the add to portfolio button or may cancel.

In one embodiment, the add cash feature displays when there is not enough cash in the cash account to cover the manual transaction.

In an exemplary embodiment of the present invention, the user 102 may view an alert (actual alert not shown) related to the asset data 108 in an alert display 600 via the display 120 within the financial advisory system 100, as shown in FIG. 6. The alert may be a gain/loss alert 602 or a price alert 604. For the gain/loss alert 602, the user 102 may enter the ticker and an alert if the gain/loss limit percent goes above/below a certain percent. For the price alert 604, the user 102 may enter the ticker and an alert if the gain/loss limit price goes above/below a certain price.

In one embodiment, the alert may be based on the asset owner's preferences entered into the risk assessment module 300 and/or the status of the value and/or capital events relating to assets in the asset data 108. In one embodiment, the database 106 may retrieve information related to the asset data 108 from a security database (not shown). One or more security databases may be stored in the database 106 and/or be accessible through the internet. For example, the security database may comprise a source with information related to the security, such as any domestic or regional stock exchange (e.g., New York Stock Exchange (NYSE) and National Association of Securities Dealers Automated Quotation (NASDAQ)). The security database may also comprise historical price information about the asset data 108, such as a high price, low price, and/or an open price for the security on any day. The security database may also store information identifying capital events that have occurred over a given period of time in connection with the various securities. The capital events may comprise, for example, spin-offs, mergers, stock splits, rights offerings, right redemptions, special dividends, return capital, original issue discounts and dividend reinvestments. The security database may comprise the capital events for the plurality of different securities. For each capital event stored in the security database, the security database may store a field corresponding to a name of a company associated with the capital event, a stock symbol associated with the capital event, a date of the capital event, a type (e.g., dividend reinvestment, stock split, spin-off, etc.) of the capital event, a shares held adjustment ratio associated with the capital event, and any other information desired to be associated with the capital event. Any suitable database structure may be used to store information identifying the capital events. The databases may be updated daily, weekly, and/or monthly for any of the information related to the asset data. The database may be updated daily, weekly, and/or monthly prices, capital events and securities.

In one embodiment, not shown, the alert display 600 may be customized by the user 102. The alert display 600 may comprise options such as, for example, ticker values, gain/loss, buy/sell, wash sale, and the like. For example, to customize the alert display, the user 102 may simply select a box for gain loss alert and wash sale, and the corresponding gain loss alert tab and wash sale tab appear on the alert display 600. The alert display 600 may also display a buy sell alert tab, which may comprise the value of an asset and/or an alert to buy or sell an asset in the asset data 108 that was uploaded into the asset data upload module and/or entered into the asset data manager module 500. The user 102 may determine that an action should be taken, such as buying or selling an asset, based on the information in the alert display 600.

In some embodiments, the report module 118 may comprise a report selector 800 that allows the user 102 to select the type of report the user 102 wishes to view or produce. As shown in FIG. 8, the report selector 800 may comprise a cash ledger report 802, a schedule D entry 804, a gain/loss summary 806, a performance rate report 808, a tax expense report 810, a dividend report 812, a corporate action history report 814, a schedule D reporting 816, an asset statement report 818, and account valuation report 820, an asset allocation report 822, and a transactions report 824.

Referring now to FIGS. 8A-8J, in some embodiments, the financial advisory system 100 may prepare various reports based on the needs of the user 102 and provide PDF format documents of the reports through the report module 118. For example, in one embodiment, the user 102 may select to sell an asset in the asset data 108 held in the asset owner's portfolio to comport with modifying the existing asset allocation scheme to match the assets in the target asset allocation model. Such a sale may have tax consequences. The tax optimization system 116 may assist the user 102 in identifying the optimal tax lots for the sale. In one embodiment, the user 102 may desire to view the tax consequences of the asset portfolio in any given year.

The cash ledger report 802, shown in FIG. 8A, may comprise a transaction date, a number of transactions, a receipt amount, a disbursed amount, a day balance. While not shown, the cash ledger report also may display current cash in hand amount at the bottom of the page. The day balance represents the balance of cash for all of the activities in a day. This day balance amount is the difference between credits to cash, the receipt amount, as well as the debits to cash, the disbursed amount. The transaction date fields are customizable and a user 102 can input a custom date range (start date/end date) or use the arrows at the bottom of the report to scroll through the years. This cash ledger report 802 can be exported to Excel, PDF or Word format.

The schedule D entry 804, shown in FIG. 4B, can be used to input additional information necessary to populate a complete Schedule D form. The schedule D entry 804 may comprise may comprise an add detail tab, a short term tab, and a long term tab. The schedule D entry 804 may allow the user 102 to enter K-1 form information and upload the K-1 form information into a schedule D tax form. K-1 forms are primarily generated from “pass through” entities such as: Limited Partnerships, Master Limited Partnerships, Partnerships or LLC's. The K-1 form information may comprise a short term gain/loss from schedule K-1, a short term gain/loss from forms, a short term capital loss carryover, a tax rate, a year, a long term gain/loss from schedule K-1, a long term gain/loss from forms, a long term capital loss carryover, a tax filing, and a capital gain distribution. Once the user has input the K-1 form information, the user 102 may select add details to schedule D tab 826 to upload the information. Alternatively, the user 102 may cancel by selecting the cancel option.

The gain loss summary option 806, shown in FIG. 8C may comprise an open lots tab and a closed lots tab. The open lots tab displays the current value of assets. The closed lots tab displays realized values on all assets sold. The gain/loss values are the difference between the adjusted cost basis and the market value (unrealized) or sale proceeds (realized). The date fields are customizable and a user can input a custom date range or use the arrows at the bottom of the report to scroll through the years. This report can be exported to Excel, PDF or Word format.

The gain loss summary option 806 shows the current unrealized gain or loss (in both percentage and absolute) of each open and closed position. The unrealized gain or loss may be defined as the difference between the cost and the current market value the asset.

In one embodiment, the gain loss summary option 806 may provide summary information for the gain and/or loss in value of the various assets in the asset data 108 during a customized date range designated by the user 102. The gain loss summary option 806 may assist the user 102 in determining whether to sell an asset in asset data 108 in response to an alert from the alert display 600 and/or recommendations for the adjustment amount. The user 102 may enter the customized date range comprising a start date and an end date. The user 102 may then select the go option and the gain loss summary option 806 will provide the summary information.

The gain loss summary option 806 shows the current unrealized gain or loss (in both percentage and absolute) of each open and closed position. The summary information may comprise a transaction type, name, ticker symbol, amount of shares, acquisition date, cost basis, market value, unrealized gain/loss, gain/loss percentage, and position type. The transaction type may comprise the option dividend or purchase.

The performance report 808, shown in FIG. 8D, calculates performance rates on all open tax lots. For this report, performance is measured by using the CAGR or Compound Annual Growth Rate formula. The date fields are customizable and a user can input a custom date range or use the arrows at the bottom of the report to scroll through the years. The performance report 808 can be exported to Excel, PDF or Word format.

The performance report 808 may comprise a transaction type, name of asset, symbol, number of shares, acquisition date, cost basis, market value, CAGR % and short term/long term. The performance report 808 may comprise a summary of the year-to-year growth of an asset over a specified period of time, assuming a steady rate of growth over that time. The performance report 808 shows the current unrealized gain or loss for each tax lot position. The performance report 808 may assist the user 102 in determining whether to sell an asset in asset data 108 in response to an alert from the alert display 600 and/or recommendations for the adjustment amount. The performance report 808 may inform an asset owner of the long term prospects of holding an asset by viewing the annualized gain or loss of the asset, but may not inform the asset owner of the short term changes in value that may have occurred over the specified time.

Referring now to FIG. 8E, the tax expense 810 option estimates tax expenses for a selected year. In one embodiment, tax expense report option 810 allows the user 102 to enter tax information comprising a year, short term and ordinary tax rate, long term and qualified dividend tax rate, short term carry over loss, long term carry over loss, and qualified dividend income amount. The user 102 may select the tax year from the dropdown menu. Once the user 102 has entered the tax information the user may select the go option and a tax expense report will be displayed. The results will display the securities sold during that tax year, total the capital gains and apply proper adjustments to the tax owed. This tax expense 810 report can be exported to PDF or Word format.

The tax expense report may comprise a security name/symbol, acquired date, sale date, position type, i.e., whether short term/long term, cost basis, proceeds/sale amount, realized gains or loss, tax rate and tax amount each of which are based on the tax information entered by the user 102.

The dividends report 812, shown in FIG. 8F details dividends that have been received and the reinvestment tax lots. The date fields are customizable and the user 102 can input a custom date range or use the arrows at the bottom of the report to scroll through the years. The dividend report 812 displays the dividends received into the portfolio. The dividend report 812 may comprise dividend summary information.

The dividend summary information may comprise a symbol, name, pay date, dividend rate percent, cash amount received, reinvested shares, new shares balance, new cost basis, and type. The type may comprise a short term or long term.

In one embodiment, the dividend report option 812 may provide dividend summary information for the dividends received for the various assets in the asset data 108 during customized date range designated by the user 102. The dividend report option 812 may assist the user 102 in determining whether to sell an asset in asset data 108 in response to an alert from the alert display 600 and/or recommendations for the adjustment amount 722. The dividend report 812 can be exported to Excel, PDF or Word format.

The activity report 814 provides an audit trail of events for each security. The user may select the ticker from the dropdown menu and then select the ‘Go’ button to view the report. The activity report 814 will detail all personal events, (i.e. buys and sells), as well as corporate events (i.e. dividends, stock splits). The date fields are customizable and a user can input a custom date range or use the arrows at the bottom of the report to scroll through the years. The activity report 814 can be exported to Excel, PDF or Word format.

Referring now to FIG. 8G, in one embodiment, the user 102 may select the activity report 814. The activity report 814 may comprise corporate information for each asset in the portfolio. The corporate information may comprise all corporate action, event information, and history for each asset in the portfolio. Some examples of corporate information comprise corporate action, expiration date, date of record, original total shares, original total cost basis, dividend rate, and the like. The user may simply select an asset from the drop down menu to display the corporate information.

The schedule D report 816, shown in FIG. 8H can populate the Schedule D and 8949 tax forms. The user 102 starts by selecting the tax year from the dropdown menu and can then click on the link that appears to view the PDF version of the Schedule D and 8949 forms. This can be printed, emailed or saved directly to your computer. The schedule D option 816 allows the user 102 to download PDF reports in the report module 118 by selecting the year of tax information to populate into a schedule D tax form based on the facts of the sale. The financial advisory system 100 may apply wash sale adjustments and adjustment codes to the tax forms. The reports may be populated across accounts, such as, for example, where a single portfolio may have two or more associated investment accounts that can be consolidated and reported on.

In one embodiment, the schedule D tax form may be populated manually by the user 102 entering K-1 form information and/or the schedule D tax form may be populated automatically by the financial advisory system 100. The user 102 may then download and print, transfer, file, and/or save the PDF document.

The asset statement option 818, shown in FIG. 8I displays a breakdown of the asset allocation and lists the market value and cost basis on all current holdings. The user 102 can select the year from a drop down menu and can view the information for that year. The asset statement option 818 displays a summary of positions held in the account. The asset statement option 818 allows the user 102 to store and view account statements from various accounts from custodians and brokerage firms. The bottom of the report totals the asset value based on the current date. The asset statement option 818 report can be exported to Excel or PDF format.

Referring now to FIG. 8J, in one embodiment, the user 102 may select the account valuation option 820. The account valuation report 820 displays the quarterly values of all the accounts within the financial advisory system 100 for the selected year. A user can select the year from the dropdown and the report will populate. The account valuation option 820 provides a summary valuation of all holdings for the chosen year. The account valuation option 820 allows the user to view a summary of all accounts within their portfolio(s). The bottom of the account valuation report 820 totals the account values based for each quarter. The account valuation report 820 can be exported to Excel or PDF format.

The asset allocation report 822, shown in FIG. 8K allows the user 102 to drill down on the asset categories to create a dynamic view of the holdings. The asset allocation report includes an open position tab and a closed position tab. The user can select the asset categories comprising equity, fixed income, real estate, and commodities. The user can also select a sub-category, for example, the equity category has a sub category or Stock, Mutual Funds and Options. Mutual Funds are also included in the Fixed Income category. The user 102 can highlight the level they would like to view and select the ‘Go’ button. As the results change, so does the pie chart. This asset allocation report 822 can be exported to Excel, PDF or Word format.

The transactions report 824, shown in FIG. 8L displays all purchases, reinvested dividends and sales. The asset categories are divided by 5 tabs comprising stocks/mutual funds, real estate, fixed income, option and commodities. The Total is the sum of the asset values divided by category. The subtotal represents the sum for the page displayed. The date fields are customizable and a user can input a custom date range or use the arrows at the bottom of the report to scroll through the years. This transactions report 824 can be exported to Excel, PDF or Word format.

A method of operation according to various aspects of the present invention may comprise accessing the graphical user interface 104 by the user 102. The user 102 may enter the asset owner's preferences into the risk assessment module 300 via the graphical user interface 104, such as the asset owner's attitude toward the economy, tolerance of changes in asset value, and/or long term financial goals and the like. Information relating to market trends may be retrieved by the database 106. The asset allocation engine 112 may then generate the target asset allocation model based on the information entered into the risk assessment module 300 by the user 102 and the information relating to market trends retrieved by the database 106. The user 102 may upload asset data 108 into the asset data upload module 500. The asset allocation engine 112 may generate an existing asset allocation scheme based on the asset data 108. The asset allocation engine 112 may analyze the difference between the existing asset allocation scheme and the target asset allocation model to identify deficiencies. The asset allocation display, shown in FIGS. 10A and 10B, may display actions needed to achieve the target asset allocation model.

Optionally, the user 102 may select for the financial advisory system 100 to evaluate the consequences of taking the actions needed to achieve the target asset allocation model, such as buying, selling, or moving assets. For example, the user 102 may select to sell the asset and may view the optimal tax lots for disposal, as determined by the tax optimization system 116. The user 102 may also select for the report module 118 to generate a report, such as the schedule D 804 tax form, the gain loss term based summary 810, the CAGR summary 812, and/or the dividend summary 816. The report may be viewed and/or downloaded by the user 102 through the display 120.

In various embodiments the user 102 may also utilize the performance engine 122 to utilize the asset data 108 to calculate market valuations and assess and/or evaluate investment performance of the assets and securities in the user's portfolio. The financial advisory system 100 may also utilize the asset data 108 to calculate market valuations and assess and/or evaluate investment performance of the assets and securities in the user's portfolio via the performance engine 122. In addition the financial advisory system 100 allows the user to calculate market valuations and assess and/or evaluate investment performance for all the user portfolios and accounts. For example, the financial advisory system 100 via the cost basis engine 114 calculates adjusted cost basis on stocks and mutual funds in the following manner: financial advisory system 100 collects asset data 108, such as, for example, trade log information imported by user 102 and/or from any other source, such as, any suitable repository database containing information about the asset and stores the asset data 108/information in the database 106. This asset data 108 information contains transaction history such as buys/sells for each security/asset. The financial advisory system 100 via the cost basis engine 114 utilizes cost basis algorithms to calculate the trade data of the security/asset against financial advisory system 100 corporate action data stored in the database 106 and adjusts the cost basis quantity of shares owned for capital events such as stocks splits, stock dividends, dividends, stock mergers, cash mergers, bankruptcies, stock and cash mergers, spin-offs and return of capital. Using the original purchase value of a security/asset, the financial advisory system 100 via the performance engine 122 adjusts that value of the security/asset based on the corporate action event that occurs. The adjusted cost basis may be stored in the database 106 of the financial advisory system 100 and is used by the performance engine 122 to calculate accurate gains/losses. The performance engine 122 calculates the gain/loss by taking the quantity of shares sold and sale proceeds from the trade log/asset history and applies to the purchase tax lots using the sale methodology designated by the user. The performance engine 122 may then generate an alert, as is discussed in detail above. The sale methodologies include the following accounting methods: FIFO (first in first out), HIFO (highest in first out), LIFO (last in first out) or LOFO (lowest in first out.) The default method for this is FIFO (the standard accounting method designated by the broker). Based on the methodology used for sale, the gain/loss could have different outcomes and therefore different tax implications. The financial advisory system 100 has the capability to run all four sales methodologies on any given sale.

Optionally, the user 102 may select for the financial advisory system 100 to evaluate the consequences of taking the actions needed to achieve the target asset allocation model, such as buying, selling, or moving assets. For example, the user 102 may select to sell the asset and may view the optimal tax lots for disposal, as determined by the tax optimization system 116. The user 102 may also select for the report module 118 to generate any of the reports discussed above. The report may be viewed and/or downloaded by the user 102 through the display 120.

The invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, 11 required or essential features or components.

The terms “comprises”, “comprising”, or any variation thereof, are intended to reference a non-exclusive inclusion, such that a process, method, article, composition, system, or apparatus that comprises a list of elements does not include only those elements recited, but may also include other elements not expressly listed or inherent to such process, method, article, composition, system, or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

The present invention has been described above with reference to an exemplary embodiment. However, changes and modifications may be made to the exemplary embodiment without departing from the scope of the present invention. These and other changes or modifications are intended to be included within the scope of the present invention.

1. A financial advisory system for evaluating a plurality assets for an asset owner, comprising:
a user interface, provided by a computer, configured to receive identifying information about the plurality of assets via an application program interface;
a database, provided by a computer system, communicatively linked to the application program interface and configured to:
store the identifying information;
retrieve asset data from a repository database, the asset data comprising historical information about the plurality of assets; and
retrieve information about market trends from an authoritative source;
a performance engine, provided by a computer system, communicatively linked to the database and configured to:
calculate an investment performance of the plurality of assets;
generate an alert in response to a sale of at least one of the plurality of assets; and
a display configured to present a report of the activity of the plurality of assets.

2. The financial advisory system of claim 1, wherein the information about the plurality of assets comprises an open financial exchange file.

3. The financial advisory system of claim 1, wherein the sale comprises a wash sale.

4. The financial advisory system of claim 1, wherein investment performance of the plurality of assets comprises a sale using a user selected sale methodology.

5. The financial advisory system of claim 4, wherein the user selected sale methodology comprises at least one of FIFO, HIFO, LIFO, and LOFO.

6. The financial advisory system of claim 1, wherein the information about the plurality of assets further comprises a number of shares of a security, a purchase date, and a price per share.

7. The financial advisory system of claim 1, wherein the historical information comprises at least one of a performance of the security over time, a capital event, and a shares held adjustment ratio.

8. The financial advisory system of claim 6, further comprising a tax optimization system configured to identify a tax lot of the security to sell to achieve the target asset allocation model.

9. The financial advisory system of claim 1, the display further comprising a report, wherein the report comprises at least one of a tax form populated with information about an asset to be sold, a gain and loss term based summary, a compound annual growth rate summary, a tax expense summary, and a dividend summary.

10. The financial advisory system of claim 1, the display further comprising an alert, wherein the alert comprises a notification to the user of an event related to the asset in the existing asset allocation scheme.

11. The financial advisory system of claim 10, wherein the notification comprising information about at least one of a capital event and a change in value.

12. The financial advisory system of claim 1, wherein the plurality of assets comprises an investment portfolio owned by the asset owner.

13. A method, implemented by a computer comprising a processor, for evaluating a plurality assets for an asset owner, comprising:
receiving identifying information about the plurality of assets of the asset owner;
storing the identifying information in a database provided by a computer system;
retrieving asset data from a repository database, the asset data comprising historical information about the plurality of assets;
retrieving information about market trends from an authoritative database;
calculating, by the processor, investment performance of the plurality of assets;
generating, by the processor, an alert in response to a sale of at least one of the plurality of assets displaying a report of the activity of the plurality of assets.

14. A method, implemented by a computer comprising a processor, for evaluating a plurality of assets for an asset owner according to claim 13, wherein the sale comprises a wash sale.

15. A method, implemented by a computer comprising a processor, for evaluating a plurality of assets for an asset owner according to claim 13, wherein investment performance of the plurality of assets comprises a sale using a user selected sale methodology.

16. A method, implemented by a computer comprising a processor, for evaluating a plurality of assets for an asset owner according to claim 15, wherein the user selected sale methodology comprises at least one of FIFO, HIFO, LIFO, and LOFO.

17. A method, implemented by a computer comprising a processor, for evaluating a plurality of assets for an asset owner according to claim 13, wherein the information about the plurality of assets further comprises a number of shares of a security, a purchase date, and a price per share.

18. A method, implemented by a computer comprising a processor, for evaluating a plurality of assets for an asset owner according to claim 13, wherein the historical information comprises at least one of a performance of the security over time, a capital event, and a shares held adjustment ratio.

19. A method, implemented by a computer comprising a processor, for evaluating a plurality of assets for an asset owner according to claim 13, further comprising a tax optimization system configured to identify a tax lot of the security to sell to achieve the target asset allocation model.

20. A method, implemented by a computer comprising a processor, for evaluating a plurality of assets for an asset owner according to claim 13, the display further comprising a report, wherein the report comprises at least one of a tax form populated with information about an asset to be sold, a gain and loss term based summary, a compound annual growth rate summary, a tax expense summary, and a dividend summary.

21. A method, implemented by a computer comprising a processor, for evaluating a plurality of assets for an asset owner according to claim 13, the display further comprising an alert, wherein the alert comprises a notification to the user of an event related to the asset in the existing asset allocation scheme.

22. A method, implemented by a computer comprising a processor, for evaluating a plurality of assets for an asset owner according to claim 21, wherein the notification comprising information about at least one of a capital event and a change in value.

23. A method, implemented by a computer comprising a processor, for evaluating a plurality of assets for an asset owner according to claim 13, wherein the plurality of assets comprises an investment portfolio owned by the asset owner.
